(19) United States
(12) Patent Application Publication
(10) Pub. No.: US 2005/0240444 A1
(43) Pub. Date: Oct. 27, 2005

(54) System and method of individualized mass diagnosis and treatment of obesity

(76) Inventors: Richard Wooten, Tigard, OR (US); Al Libke, Ketchum, ID (US)

Correspondence Address: JAMES E. PARRIS, P.O. BOX 233, HAILEY, ID, 83333, US

(21) Appl. No.: 10/832,731

(22) Filed: Apr. 26, 2004

(51) Int. Cl. G06F 17/60

(52) U.S. Cl. 705/3

(57) ABSTRACT

An individualized system and method of mass diagnosis and treatment of obesity that is optionally configurable for a plurality of patients and health providers. Computer and relational data storage systems are used for operating a computer program and a secure web site on an internet. User profiles are assigned for accessing the secure web site using a plurality of computer terminals. Patient data and information are gathered for use in a health risk analysis to determine values for variables in a caloric energy equation. An individualized health provider web page is used to administer a meal plan, an exercise plan and an education plan to influence variables in the caloric energy equation to derive an individualized caloric energy deficit and a starvation response threshold in the patient. Patient compliance information is gathered for use in the health risk analysis and for correlation with the stored data to re-derive the variables.

### FIELD OF INVENTION

The invention relates to a system and method of individualized mass diagnosis and treatment of obesity, and more specifically, the invention relates to an individualized system and method of mass diagnosis and treatment of obesity that is optionally configurable for a plurality of patients and health providers. The diagnosis and treatment method includes providing a computer and data storage system for operating a computer program and a secure web site on the internet. User profiles enable health providers and patients to access individualized obesity treatment web pages. The health provider web pages are individualized according to user profiles and patient lists. Patient web pages are individualized according to user profiles, examination results and health provider instructions. Health risk factors associated with chronic disease is prevented or mitigated by the accurate diagnosis and individualized treatment of obesity. The invention includes a method of using an expert system and internet technologies to create and deliver individualized obesity prescriptions and treatment plans. Body fat and lean body mass percentages are used for determining basal metabolic rate to derive an individualized caloric energy equation.

### BACKGROUND OF THE INVENTION

The rising cost of healthcare has become an economic problem of great magnitude. If allowed to continue, these costs will become unsustainable. It is finally recognized that obesity plays a central role in driving chronic diseases such as type II diabetes, hypertension, hyperlipidemia, stroke, coronary artery disease and heart attacks, all of which contribute substantially to these escalating healthcare costs.

Additionally, it is now recognized that preventive medicine offers a sustainable long-term solution for healthcare cost containment.

The National Institutes of Health in 1986 defined obesity as “an excess of body fat frequently resulting in a significant impairment of health”. The ability for health providers to accurately diagnose and treat obesity on an individual basis for a mass of patients has eluded health providers for many years. These problems stem from the limited amount of time health providers have available for their patients and the health provider's inability to make an accurate diagnosis of obesity using scientifically valid percent body fat measurements. Further, these problems are exacerbated by the inability to provide an effective means of individualized treatment in a clinical setting, where these settings comprise outpatient, extended nursing, fitness club, home therapy, corporate, and educational clinics to name a few. Here health providers comprise medical doctors, nurses, therapists, nutritionists or other professionals promoting health and wellness to name a few.

Mass treatment of obesity requires the health provider to implement a spectrum of individualized treatment plans, where one treatment plan may stipulate careful patient monitoring and another may allow for some patient self-direction. Individualized obesity treatment plans are complicated, expensive and time consuming to derive.

In the past, the body mass index has been the primary tool used to diagnose obesity, where body mass index is derived by measuring the patient's weight in kilograms and height in meters then apply that data to the formula (body mass index=kilograms/meter²). The body mass index value is used to make a statistical diagnosis of obesity. It is now known that there are significant errors associated with this body mass index value when used to determine the appropriate diagnosis and obesity prescription for any individual patient, since only the patient's height and weight are used and there is no indication of the patient's actual leanness or fatness.

The use of height-weight indices only approximates the degree of obesity. A more accurate method to determine obesity is by measuring a patient's percent body fat. This method has traditionally required expensive and technically sophisticated techniques available only in research laboratories, such as the “gold standard” technique of hydrostatic weighing.

Hydrostatic weighing is essentially a mathematical prediction based on measurements of a subject in a water tank and is considered to be one of the most accurate methods of body composition analysis. The equipment required to perform hydrostatic measurements is a bulky, large 1,000-gallon tank of water that must be maintained at a constant temperature.

Required equipment for hydrostatic weighing includes apparatus to measure residual lung volume and a calibrated scale attached to an underwater chair. Patients are instructed to exhale as much air a possible from their lungs and are then immersed for 10 to 15 seconds for an underwater weight measurement to be taken. Hydrostatic measurements are based on the fact that the density and specific gravity of lean tissue is greater than that of fat tissue. Thus, lean tissue will sink in water and fat tissue will float. By comparing a patients mass as measured underwater to their mass as measured out of the water, their body composition (lean body mass and percent body fat) may be more accurately determined. Hydrostatic weighing when done by trained researchers is appropriate to establish body composition databases and provide a reference standard for other body composition technologies, but this technique is not practical in the clinical setting.

Recently, advances in bio-impedance body composition measurement technologies have enabled more accurate diagnoses of obesity in a clinical setting. More specifically, one of the primary issues in effectively treating obesity in a clinical setting is obtaining efficient, scientifically valid measurements of percent body fat and lean body mass. These measured values are essential for health providers to make an accurate diagnosis of obesity and for creating an individualized treatment plan based on lean body mass.

The relevance of accurately determining the lean body mass in a patient has become more evident in recent years. It is now known that there exists a strong correlation between an accurate determination of lean body mass and the ability to accurately diagnose and treat obesity. With an accurate measurement of lean body mass, a clinically accurate calculation of the patients' percent body fat and basal metabolic rate may be made. The percent body fat may be used to provide the scientific basis for an individualized nutrition prescription and recommendations. Basal metabolic rate is defined as the energy requirements of the human body at rest and reflects the caloric needs of a human to maintain basic life processes over a twenty-four hour period. The basal metabolic rate can be determined by measuring the total body weight and measuring the amount of muscle mass or lean body mass. Additionally, basal metabolic rate may be used as a basis for calculating calories burned by exercise. Repeated body composition measurements throughout a treatment period enables the health provider to use percent body fat, lean body mass and the lean to fat ratio for following the patient's progress and to modify the prescription and recommendations.

Historically, accurate basal metabolic rate values have been difficult to obtain in a clinical setting. Recent advances in determining body composition have greatly simplified this process while simultaneously reducing the cost. For example, Libke, et al. (U.S. Pat. No. 4,895,163) teaches a clinical body impedance data acquisition device that accurately measures human body composition, consisting of fat tissue, lean tissue and body water. Health providers are now able to determine a patient's basal metabolic rate in a clinical setting. There exists a strong need for a method of using the accurate lean body mass measurements to determine a caloric energy equation for mass diagnosis and treatment of obesity and related diseases.

Presently, complications arise in determining an individualized obesity treatment prescription. Great care must be taken to ensure that the caloric prescription is not too low which may cause a patient to enter into a “starvation response”, where the body begins to retain fat and instead burns lean mass to make up for the excessive caloric deficit. This is not healthful weight loss and leads to the problematic “yo-yo” syndrome seen with so many efforts to lose weight. The goal is to individually tailor the caloric deficit for each individual to avoid this starvation response using lean body mass as the basis for this individualization. It is now being recognized that lean body mass can be used to calculate a unique caloric energy equation for the individual patient in determining individualized obesity treatment prescription. The caloric energy equation comprises the sum of: basal metabolic rate, specific dynamic action of foods, resting energy expenditure, activities of daily living, and calories burned by exercise resulting in total caloric requirements. The basal metabolic rate is the number of calories burned by lean body mass in a 24-hour period at complete rest, and the specific dynamic action of foods is the number of calories required to process and utilize consumed foods. The resting energy expenditure is the sum of basal metabolic rate and specific dynamic action of foods, where the resultant is the resting energy expenditure and represents the number of calories the body requires in a 24-hour period at complete rest. The activities of daily living are the approximate number of calories burned by the body during normal daily activities. Activities of daily living are added to the resting energy expenditure and to the average number of calories burned by exercise given a certain lean body mass and a certain exercise or activity program. An accurately determined caloric energy equation enables a highly individualized total caloric requirement for the patient to maintain current weight. As the caloric energy equation is determined for a patient, an individualized weight loss program can then be calculated, where a patient's specific caloric intake is prescribed to achieve weight loss of excess body fat without entering the starvation response threshold and burning lean mass instead of fat.

With most diet programs, if too few calories are consumed, the metabolism is lowered which in turn signals the body to require fewer calories. Typically, the patient will continue with their normal activities of daily living and their body requires substantially more calories than the diet allows. The body will look to the fat reserves for the calories needed and will use that reserve to the extent the fat tissue can be converted to usable energy. If substantially too few calories are consumed, the body cannibalizes its lean body mass to make up for the deficiency in calories. Big muscles, such as thigh muscles, have more lean body mass and need more calories than small muscles, such as finger muscles, to survive. For this reason, diets that specify too few calories achieve weight loss primarily from lean body mass reduction in large muscles instead of fat tissue to the extent of the rate that the body can assimilate fat for energy. Simply stated, a patient eats less than they need which lowers their metabolism and their muscles get smaller. They may have substantially the same amount of fat but they weigh less due to the reduced lean body mass. In this typical case with traditional dieting, the heath risk factors have not been reduced and economic benefits from reducing health risk factors are not achieved.

A limit exists where the muscle tissue becomes insufficient to sustain the calorie deficiency, at this juncture the patient will become exceptionally hungry and enter a binge response where they eat more food such that their weight increases dramatically resulting in a much higher body fat content; this is known as a “starvation response”, and the “yo-yo” syndrome. When prescribing dietary caloric amounts and ingredients to an obese patient, it is now known that a starvation response occurs when too few calories or improper ratios of proteins, carbohydrates, fats, rest and exercise are prescribed for the patient's diet.

Though technological advancements have enabled more health providers to accurately measure lean body mass in a clinical setting and derive an individual caloric energy equation for each patient, there exist problems in prescription fulfillment for treating obesity on a mass scale. For example, when a patient visits a health provider and receives a prescription diet, the patient will usually not see or correspond with the health provider for several weeks due to the limited time available from the health provider. Over this time, the patient may have inadvertently exceeded the starvation response threshold one or more times resulting in a subsequent weight gain, thus becoming discouraged and discontinued the prescription. Unlike most chronic illnesses, effective treatment of obesity requires substantial nurturing and health provider-to-patient interaction. One primary problem in treating obesity is the inability for a health provider to provide the required time to effectively communicate with the patient, due to the health provider's limited time. Additionally, a patient is often left to their own direction to determine appropriate dietary and menu combinations, where they often select dietary combinations that are outside the prescriptive diet.

Often the patient has little interaction with the health provider once outside the clinical setting. In the limited time the health provider has to spend with the patient, in addition to the examination, the health provider must educate the patient about the relation of health to nutrition, diet, exercise and psychology, among others. The patient may absorb a fraction of the information and leave the clinic with trepidation and uncertainty or even abandonment.

Further, the health provider must base the prescription on information from the patient attained by asking direct, face-to-face questions such as exercise frequency, eating habits and alcohol consumption, among others. It is now known that under face-to-face interaction, the patient generally is not entirely forthcoming, resulting in an inaccurate prescription. Further, it is now well know that when obese patients are afforded some level of anonymity or privacy they tend to be more truthful with such information.

In subsequent visits with the patient, the health provider will have a measure of the patient's degree of prescription compliance only by measuring the lean body mass, but will not specifically know why the patient is not losing weight, or even gaining weight, due to the substantial time required to communicate with the patient.

What is needed is a method of using a patient's accurately measured percent body fat and lean body mass, to determine an individualized caloric energy equation and starvation response threshold and enable an accurate prescription to be made. Further, there is a strong need for a method enabling regular interaction between the patient and health provider in a cost-effective and time efficient manner. As the patient undergoes treatment for obesity, their body-needs change with time. What is needed is a method and system for the patient, in a passive setting, to provide the health provider with current daily information, such as food consumed, exercise undergone, alcohol consumed and sleep attained. Additionally, there is a real need for individualized dietary prescriptions that can be readily regulated and modified by the health provider according to the actual diet and exercise experienced by the patient, yet without significantly impacting the time required of the health provider.

In view of the serious economic loss that can result from not having a fully-functional mass method of treating obesity, a strong need exists for a method and system to derive a personalized prescription yet optimizing the health provider's time so as to not impede treatment of other obese patients. The substantial face-to-face man-hours required of a health provider to have adequate supervision over an obese patient's diet, exercise and psychology on a daily basis is increasingly cost prohibitive to insurance companies and health care organizations. Additionally there exists a substantial logistical and financial roadblock in such supervised care, since the patient cannot see the health provider on a daily basis unless the patient is placed in an admitted hospital situation.

Various methods of providing adequate healthcare for obese patients have been proposed. See for example, Lazarus (U.S. Pat. No. 5,851,531) where the treatments include brain stimulation and drug infusion. Other documents concerning the mentioning of patient information analysis management system and methods include Yokota et al. (U.S. Pat. No. 5,713,350). Some of these documents concern multimedia applications, see Ballantyne et al. (U.S. Pat. No. 5,867,821.)

Some of these documents concern computer-assisted methods for treating pain see for example Brynjestad (U.S. Pat. No. 5,908,383). (All of the foregoing documents and any other documents discussed or otherwise referenced herein are incorporated herein in their entireties for all purposes.)

Accordingly, there has been a long-standing need for a practicable method to obtain accurate lean body mass values for obese patients in the clinical setting and derive useful prescriptions that can be readily modified by the member health provider as the patient conveys current health status information while still being technologically, economically and otherwise practicable.

### BRIEF DESCRIPTION OF THE DRAWINGS

FIG. 1 depicts an operating platform.

FIG. 2 depicts an operating platform flow diagram.

FIG. 3 depicts an obesity treatment plan flow diagram.

FIG. 4 depicts an individualized education plan.

FIG. 5 depicts an individualized health provider web page.

FIG. 6 depicts an add patient web page.

FIG. 7 depicts an continued add new patient web page.

FIG. 8 depicts a patient data web page.

FIG. 9 depicts an edit patient meal plan web page.

FIG. 10 depicts a sample edit food item web page.

FIG. 11 depicts a sample edit food item web page.

FIG. 12 depicts a patient activity plan web page.

FIG. 13 depicts an edit patient aerobic activity plan web page.

FIG. 14 depicts an edit patient resistance activity plan web page.

FIG. 15 depicts an edit caloric recommendation web page.

FIG. 16 depicts a individualized multi-week lesson planner web page.

FIG. 17 depicts a patient meal plan web page.

FIG. 18 depicts a patient edit food item web page.

FIG. 19 depicts an patient edit food item web page.

FIG. 20 depicts a nutrition analysis web page

FIG. 21 depicts a meal and food group analysis web page

FIG. 22 depicts a food item selection web page.

FIG. 23 depicts a food item amount web page.

FIG. 24 depicts an aerobic exercise schedule web page.

FIG. 25 depicts a patent edit aerobic activity plan web page.

FIG. 26 depicts a resistance exercise schedule web page.

FIG. 27 depicts an edit patient resistance activity plan web page.

### DETAILED DESCRIPTION OF THE INVENTION

Such obesity treatment methods having those features and advantages as well as other features and advantages, have now been developed. The invention comprises an individualized system and method of mass diagnosis and treatment of obesity that is optionally configurable for a plurality of patients and health providers. The system and method provides a computer and relational data storage system for operating a computer program and secure web site on the internet. The secure website is accessed and displayed using a plurality of computer terminals. The web site comprises a plurality of individualized obesity treatment web pages related according to the computer program instructions, where the computer program instructions perform the steps of correlating information input from users with information stored in the relational database for displaying results on a plurality of computer terminals.

The obesity treatment method comprises the steps of using an individualized caloric energy equation to derive an individualized caloric energy deficit for an obese patient to lose weight. The method comprises the steps of using patient diagnostic data and a health risk analysis to define values in the caloric energy equation. The method further comprises the steps of quantifying exercise regimes, educational curriculums and meal plans to determine values for use in the caloric energy equation enabling the individualized caloric energy deficit to be determined.

In one embodiment, the invention provides a means of altering a patients lifestyle, exercise and eating habits to affect the patient's caloric energy equation and caloric energy deficit, where the basal metabolic rate varies with exercise and diet, the activities of daily living varies with nutrition and lifestyle education, and calories burned by exercise vary with aerobic and resistance exercises.

Further, the current invention provides the patient with an individualized caloric energy equation and a basal metabolic rate value, enabling an individualized nutrition analysis, nutrition plan, education curriculum, meal plan, and individualized nutritional supplementation program, where the individualized meal plan comprises specifying individualized caloric values for percent protein, percent carbohydrate and percent fat in the diet.

The current invention enables an individualized activity and exercise plan to be based on the patient user profile and diagnostic data. The outcome data is collected for individual patients and groups and used to modify future treatment parameters.

In one embodiment of the invention, individualized web pages may be optionally configured for a plurality of health providers and patients, where a health provider comprises medical health providers and wellness providers, and a patient comprises medical patients and wellness participants. Here, the medical health providers comprise licensed medical doctors and nurses having expertise in blood handling and analysis in addition to obesity treatment, whereas wellness providers comprise health providers not licensed for blood handling and analysis yet specialize in promoting healthful living. Medical patients comprise patients who have blood analysis results included in the patient diagnostic data, and the wellness participants comprise patients without blood analysis included in their patient diagnostic data. In this discussion, a patient comprises medical patients and wellness participants, and a health provider comprises medical professionals and wellness providers. The diagnostic data comprise the initial diagnostic data and follow up diagnostic data.

The medical patient diagnostic data comprises the examination date, the patients date of birth, gender, blood laboratory values, height measurement, weight measurement, electro lipo-graph measurement, systolic measurement, heart rate measurement, waist measurement, hips measurement and the date the treatment plan was created. The blood laboratory values comprise, cholesterol, triglycerides, hemoglobin A1C, high-density lipid protein, low-density lipid protein, C reactive protein, lipid peroxidase, glucose and homocysteine.

The wellness participant diagnostic data are similar to the medical patient diagnostic data, however the blood analysis data is not included. Specifically, the wellness participant diagnostic data comprises an examination date, date of birth, gender, and measurements for height, weight, body composition, systolic blood pressure, diastolic blood pressure, heart rate, waist, hips and the date the treatment plan was initiated. The computer program is optionally configured to enable and disable use of blood laboratory results in the obesity treatment program.

The health provider is assigned a user profile for access and use of the computer program, where the health provider logs into the secure web site using a username and password to display an individualized health provider web page. The health provider web page is individualized according to the health provider's user profile and patient list.

The health provider examines a patient to obtain a plurality of diagnostic data, and inputs the data to the computer program for creating a patient user profile. Further, the health provider supplies a user name and password to the patient pre-assigned to the patient user profile, where the patient logs into the secure web site to display an individualized patient web page.

In one embodiment of the invention the patient uses interactive internet technologies to log on to a secure website server hosting an interactive obesity treatment plan website. The computer program acquires proprietary patient outcome information submitted by the patient as they complete progressive stages in the prescription. The patient outcome information enables the health provider to modify future instructions so as to continually improve the precision of the prescription. One embodiment of the invention automatically presents to the health provider current up-to-date status of the patient's progress via web pages, email and internet technologies, where the status information enables the health provider to send instructions to the patient. The health provider is presented preprogrammed instructions for review, modification or acceptance prior to sending.

The options and features of the patient web page are individualized according to the patient user profile, diagnostic data, health provider instructions and obesity treatment data stored in the database. The patient user profile comprises access codes, contact information, a health risk analysis, diagnostic data, an individualized caloric energy equation, and patient provided information.

The health risk analysis is a method of providing a quantified patient health analysis generated by the computer program executing the steps of correlating data comprising: patient responses to subjective questions in a health risk analysis questionnaire, diagnostic data from the health provider, obesity treatment information provided by the expert review board and historical treatment data within the treatment plan relational data base. The health risk analysis method comprises the steps of assigning health risk values to the patient's health risks according to the patient user profile, diagnostic data and health provider instructions, where the health provider instructions comprise an exercise regime, a meal plan, and educational, lifestyle and medical instructions.

The health risk values are correlated with populations of like health risks to determine a health risk degree in the health risk range, where the health risk degree may be expressed as a percentage of a health risk range, or as a low, medium and high degree of risk in the health risk range. For example, a patient has a low health risk degree for moderate alcohol consumption versus a high health risk degree for heavy alcohol consumption. The health risk further comprises a health risk factor specifying the maximum affect a health risk has on the patient's overall health. For example, a health risk factor for tobacco use is higher than a health risk factor for caffeine use in affecting the patient's overall health. The health risk analysis is automatically updated according to the patient user profile and diagnostic data.

A health risk profile is generated by correlating a plurality of health risks having health risk degrees and health risk factors. The health risk profiles are displayed in terms of percentages of health risk, or ranges of low, medium and high. In one embodiment of the current invention, health risk profiles are further generated by correlating a plurality of health risk profiles. The health risk profiles comprise a health risk overview, a health risk age, a body composition risk profile, a coronary risk profile, cancer risk profile, a nutrition risk profile, a non-controllable risk profile, a lifestyle risk profile, a personal safety profile, a hypertension risk profile, an arthritis risk profile, an osteoporosis risk profile, a nutrition risk profile, a diabetes risk profile, and an exercise risk profile.

The patient's health risks in the health risk analysis have values according to the individual patient. The health risk values are derived from diagnostic data, hereditary attributes, lifestyle choices, age, gender and body morph type to name a few. Health risk categories comprise family history, physical activity, nutrition habits, alcohol and drugs, stress coping and anxiety, health care, safety and weight management. Each health risk category comprises a plurality of patient health risks, for example the family history health risk category comprises health risks for the patient's family history of coronary heart disease before the age of sixty and after the age of sixty, diabetes mellitus, strokes and cancer. The physical activity category comprises health risks for the patient's exercise frequency, exercise type, warm-up and cool-down and weight training. Nutrition habits health risk category comprises health risks for the patient's carbohydrate consumption, fat consumption, preparation of foods, use of cereal grain products, convenience food habits, intake of salt, daily meals, daily snacks, water consumption, use of dairy products, fruits and vegetable consumption, and meat and protein products consumed. The alcohol and drugs health risk category comprises health risks for drinking days, number of drinks, drugs and self-medication, caffeine use, smoking status and smokeless tobacco use. The stress coping and anxiety health risk category comprises health risks for stress and coping, energy level, sleep, anger and pressure management, demands and obligations, procrastination, future outlook, self-needs, respect, compulsive needs, unfair events, recognition and responsibilities. The health care health risk category comprises health risks for clinic visits, sick days, routine check-up or physical, mammogram, colon-rectal screening, prostate screening, cancer warning signs, dental check-up and eye examination. Safety health risk category comprises health risks for living environment, smoke detector use, seat belt use, driving time, automobile maintenance, and fire protection habits. The weight management health risk category comprises health risks for health and weight management, how long the patient has felt that their weight has been a problem, body fat, how many times have they been on a diet or attempted to lose weight, body fat on average over time, how much weight do they lose when they diet, description of their attempts at weight loss, have they ever experienced any bulimic events, how many individuals in their direct family have a weight problem.

One embodiment of the current invention comprises a means of generating an individualized caloric energy equation for the patient using elements of the patient's user profile, diagnostic data and health provider instructions. The patient's individualized caloric energy requirements comprise the sum of the patient's basal metabolic rate, specific dynamic action of foods, activities of daily living, and calories burned by exercise, where these patient-specific calorie energy parameters are influenced by the methods of the current invention to optimize obesity treatment. The basal metabolic rate is the patient's caloric energy requirements at rest over a twenty-four period, and is determined from the health risk analysis and is approximately 40-60% of the total caloric energy equation, where body composition measurements comprising percent body fat and lean body mass are used in the health risk analysis. The specific dynamic action of food is the patient's caloric energy requirements to process food determined from the health risk analysis, and is approximately 5-15% of the patient's total caloric energy requirements. The activities of daily living are the patient's caloric energy requirements for work, leisure and normal daily living activities determined from the health risk analysis comprising approximately 20-30% of the patient's total caloric energy requirements. Calories burned by exercise are generally 5-25% of the patient's total caloric energy requirements. In one embodiment of the current invention, the variables of the individualized caloric energy equation are variables that may be optimized to promote better health in the patient.

The result of the individualized caloric energy equation is the patient's caloric energy requirements to maintain their current weight. A caloric energy deficit is a percentage of calories removed from the patient's total caloric energy requirements to enable weight loss. A starvation response occurs when the percentage of calories removed is too large and the patient's body begins to consume lean body mass for needed calories. In the starvation response, primal body functions supersede rationale and cause the patient to engage in binge eating. A starvation response threshold is a percentage of calories removed from the patient's total caloric energy requirements when the patient enters a starvation response. An individualized starvation response threshold is generated by correlating the patient user profile and diagnostic data with the starvation response thresholds of a population of like patient user profiles stored in the relational data storage system. In one embodiment of the current invention, the individualized caloric energy equation is used to determine and individualized patient caloric energy deficit for reducing weight and treating obesity without entering the starvation response threshold. The weight reduction rate is calculated in terms of a decrease in caloric energy as opposed to reduction of pounds per week, where two patients may have identical weight to height ratios yet significantly different basal metabolic rate values.

In one embodiment of the invention, the health provider instructions comprise a diet plan, an exercise plan and education for lifestyle behavior enabling healthful living. The health provider instructions directly affect the patient's caloric energy equation. Meal and exercise instructions and lifestyle education from the health provider affect the patient's calories consumed and burned during exercise, and increasing calories expended performing activities of daily living, where activities of daily living education comprises altering a patient's approach to lifestyle activities such as using stairs versus an elevator, among many others. These variables affect the caloric deficit of the patient's individualized caloric energy equation.

In one embodiment, obesity treatment data stored in the relational database comprises a plurality of patient obesity treatment histories. The treatment history information comprises patient examination data from a plurality of health providers, user profiles and compliance information from a plurality of patients. An expert review board, specializing in obesity treatment comprises educators, industry experts and health providers. The expert review board reviews obesity treatment information such as obesity treatment efficacy trends, diagnostic data, patient health risk analysis, educational materials, prescription information and other individualized obesity treatment plan data. The expert review board provides ongoing recommendations, modifications and validation of the system data. Individualized obesity treatment prescriptions may be reviewed for possible improvements by the expert review board, where recommendations are communicated to the health provider via secure internet means.

In one embodiment of the current invention, repeated body composition measurements and patient diagnostic data are used to modify the health risk analysis and health provider instructions as the patient periodically visits the health provider. The repeated body composition measurements, patient diagnostic data and patient responses to treatment plan queries are stored in the secure relational database for access by the computer program.

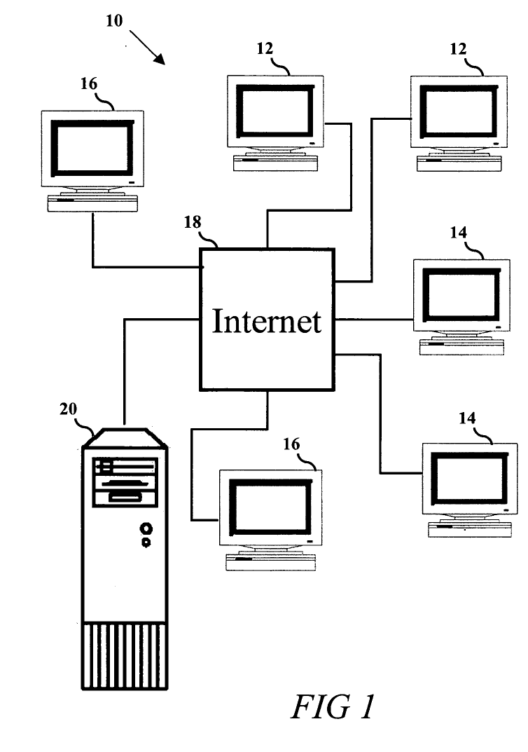

Referring now to the figures, FIG. 1 depicts an operating platform 10 for the current invention, where a plurality of health provide computer terminals 12, a plurality of patient computer terminals 14, and a plurality of expert review board computer terminals 16 are connected to an internet 18 for accessing a secure remote computer and data storage system 20 for operating a computer program and a secure web site on the internet 18.

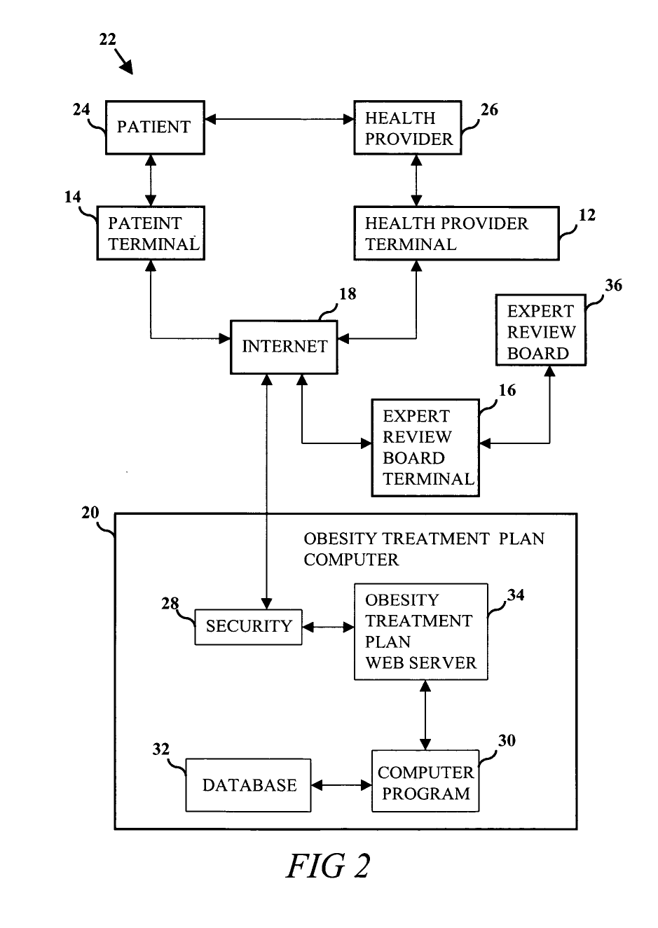

FIG. 2 depicts an obesity treatment plan operating platform flow diagram 22 of the current invention. As depicted, a patient 24 is examined by a health provider 26, where the health provider 26 inputs patient 24 diagnostic data to the computer program 30 using the health provider computer terminal 12. The health provider 26 is assigned a health provider user name and password to login to the secure web site using the health provider computer terminal 12 and internet 18. The computer security 28 verifies the username and password and grants the health provider 26 access to the obesity treatment plan web site. The secure web site displays an individualized health provider web page according to the health provider user profile. The obesity treatment plan web site server 34 is a Health Insurance Portability and Accountability Act of 1996 compliant web page server.

The health provider 26 inputs the patient's diagnostic data into the computer program 30. As further depicted in FIG. 2, the computer program 30 stores diagnostic data of the patient 24 in the relational database 32. The computer program 30 performs the steps to create an individualized patient web page in the treatment plan web page server 34 for access by the patient 24.

The health provider 26 provides the patient 24 a patient username and password to login to the secure web site using the patient computer terminal 14 and internet 18. The computer security 28 verifies the username and password and grants the patient 24 access to the obesity treatment plan web site. The secure web site displays a patient web page individualized according to the patient user profile, health provider instructions, stored obesity treatment history data and expert review board information, where the patient 24 is presented an interactive individualized patient web page for treating obesity.

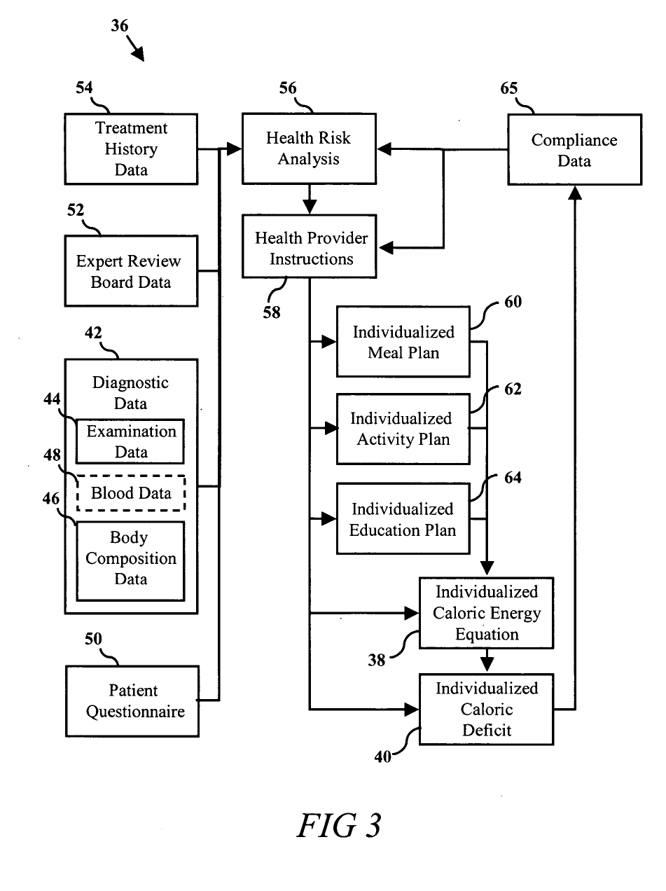

Referring to FIG. 3, the individualized obesity treatment plan method comprise the steps of deriving individualized meal, activity, and education plans, to create an individualized caloric energy equation 38 and caloric deficit 40 for the patient 24. FIG. 3 depicts an obesity treatment plan flow diagram 36 comprising the steps for creating an individualized obesity treatment plan. The patient 24 is examined by the health provider 26 to obtain patient diagnostic data 42 comprising examination data 44, body composition data 46 and blood data 48, where appropriate, and input to the computer program 30. As depicted, the blood data 48 is shown in a dashed-line box to indicate including blood data is an optional configuration of the current invention. The patient 24 is provided a health risk analysis questionnaire 50 for gathering the patient's subjective information and inputting into the computer program 30. Expert review board data 52 and obesity treatment history data 54 are input to the computer program 30 from the secure relational database 20. These data and information are correlated to create an individualized health risk analysis 56 for use in the individualized caloric energy equation 38.

The health provider 26 reviews the health risk analysis and provides health provider instructions 58 for an individualized meal plan 60, an individualized activity plan 62, and an individualized education plan 64, having preliminary default values and goals and, upon approval or modification, submits it for use in an individualized caloric energy equation 38. The health provider 26 reviews the health risk analysis and provides health provider instructions 58 for the individualized caloric energy equation 38 and caloric deficit 40.

The patient participates in the obesity treatment plan and submits compliance data 65 regarding their degree of fulfillment in the treatment plan goals. The computer program 30 correlates the compliance data to automatically adjust the treatment plan elements, described above, and presents the adjustments in an adjustment ledger (not shown) to the health provider 26 for review, modification or approval. This iterative process continually refines the obesity treatment plan efficacy as the patient 24 progresses through the daily tasks of the obesity treatment plan.

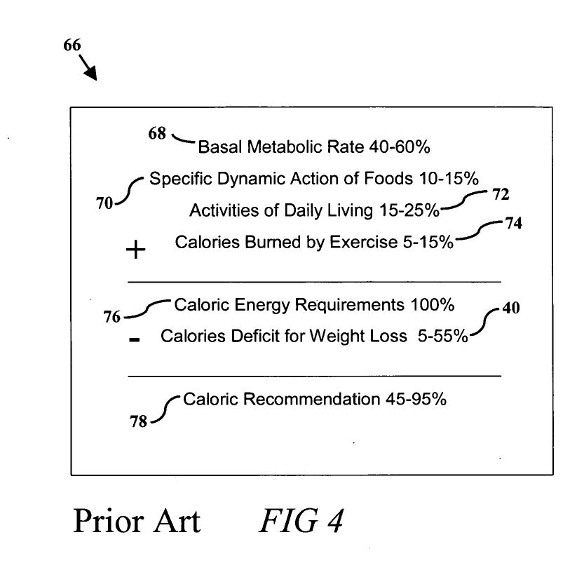

FIG. 4 depicts caloric energy equation elements 66 (prior art), where the basal metabolic rate 68, specific dynamic action of foods 70, activities of daily living 72 and calories burned by exercise 74 are summed to result in a total caloric energy requirement 76. Further depicted are the corresponding ranges of the percentage of total calories for each element, where the percentage of total calories of the basal metabolic rate 68 is between 40-60%, the specific dynamic action of foods 70 is between 10-15%, the activities of daily living 72 is between 15-25%, and the calories burned by exercise 74 is between 5-15%. The sum of these elements is the total caloric energy requirements 74 for the patient 24 to maintain their current weight. The caloric deficit 40 is subtracted from the caloric energy requirement 76 resulting in a caloric recommendation 78, where the range of the caloric deficit 40 is between 5-55%, and the caloric recommendation 78 is between 45-95% of the total caloric energy requirements. The novel aspect of the current invention is in enabling the elements of the individualized caloric energy equation 38 to be evaluated, monitored and modified to for diagnosing and treating obesity on a mass scale.

In one embodiment of the invention, a treatment plan entry web page (not shown) having a patient option, a health provider option, and a tour option provides an access portal. The health provider 26 selects the health provider option to display a health provider log in web page (not shown) prompting the health provider to enter their health provider username and health provider password and select an option to log in.

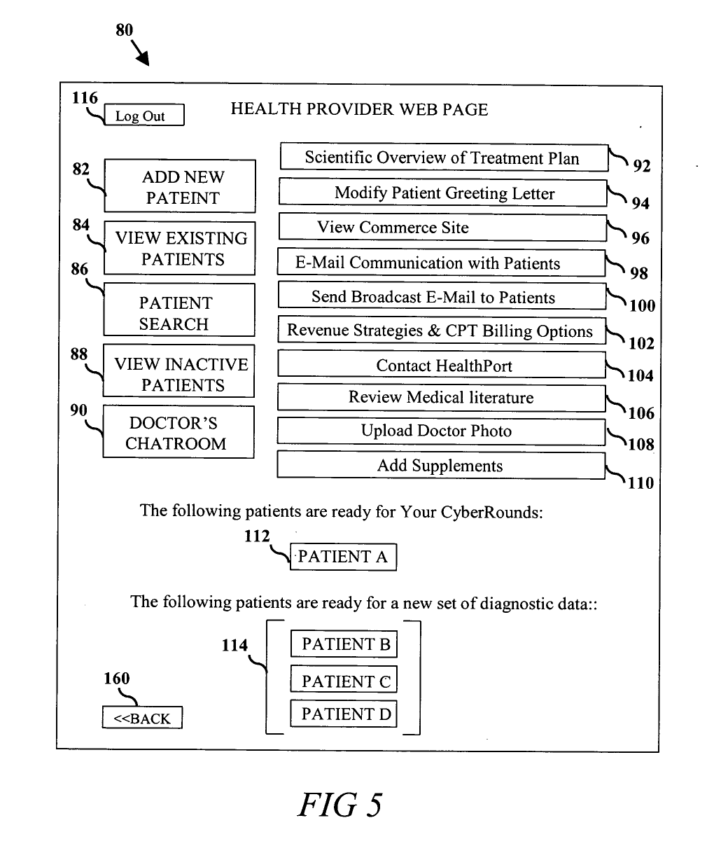

The health provider 26 is granted access to the obesity treatment plan server 34, where an individualized health provider web page is displayed. FIG. 5 depicts a typical individualized health provider web page 80, according to one embodiment of the invention, having menu options add new patient 82, view existing patient list 84, patient search 86, view inactive patient list 88, enter doctor's chat room 90, scientific overview of treatment plan 92, modify patient greeting 94, view commerce site 96, email patient 98, broadcast email to patients 100, revenue and billing options 102, contact treatment plan provider 104, review medical literature 106, upload doctor photo 108, add supplements 110, a cyber rounds patient list 112, a diagnostic data patient list 114, return to previous page 160 and an option to log out 116.

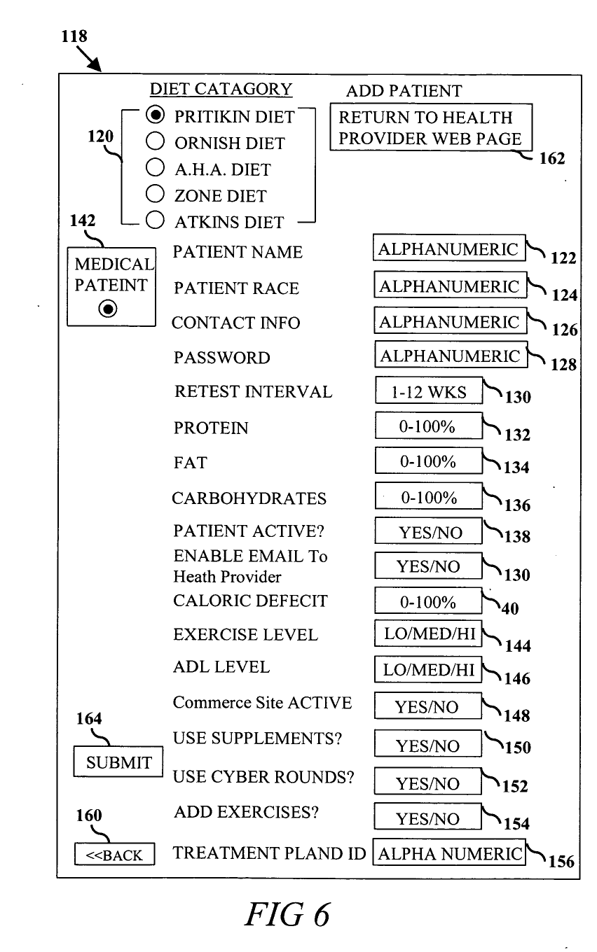

The step of selecting the add new patient option 82 displays an add patient web page 118 as depicted in FIG. 6, where, according to one embodiment of the invention, the health provider 26 is prompted to enter new patient information.

According to the add new patient web page 118, depicted in FIG. 6, the health provider 26 is prompted to perform the steps to add a new patient to the obesity treatment plan by selecting from a diet category list 120 comprising the Pritikin, Ornich, American Heart Association, Zone and Atkins diets, where each diet category has different daily intake values for protein, fat, carbohydrates, and caloric deficit values. The health provider web page automatically displays default intake percentages according to the diet selected, and prompts the health provider to accept, modify or reset the default values.

The Pritikin diet intake value for protein ranges from 0-100 percent and has a default setting of 35 percent, the fat intake value ranges from 0-100 percent and has a default setting of 5 percent, the carbohydrate intake value ranges from 0-100 percent and has a default setting of 60 percent. The Pritikin diet principle is based on the importance of calorie deficit for weight loss. Instead of calculating calories per food item, health providers plan the calorie-content of a meal by following the Pritikin rankings of foods according to calories per pound and by choosing regular servings of low-calorie and medium-calorie foods (e.g. fruits, vegetables, bread, rice and pasta), with only occasional use of high-calorie foods. Health providers create meals with an average of 400 calories or less per pound of food. The Pritikin diet is high in fiber, low in cholesterol and extremely low in fat (less than 10 percent of daily calories).

The Ornish diet intake value for protein ranges from 0-100 percent and has a default setting of 15 percent, the fat intake value ranges from 0-100 percent and has a default setting of 10 percent, the carbohydrate intake value ranges from 0-100 percent and has a default setting of 75 percent. The Ornish diet is basically vegetarian, allowing no meat, poultry, or fish and permitting only the white of eggs. Also, no nuts, caffeine, or dairy products, except a cup a day of nonfat milk or yogurt, are allowed, and no fat is permitted. Two ounces of alcohol a day are allowed. Providing an average of about 1,800 calories a day, the diet provided 75 percent of its calories from carbohydrates and less than 10 percent from fat. The Ornish diet invokes stress reduction practices, in addition to the diet, and emphasizes emotional social support systems, particularly between members of the patient group. It also requires daily stretching and an hour's walk three times a week.

The American Heart Association (A.H.A.) diet intake value for protein ranges from 0-100 percent and has a default setting of 30 percent, the fat intake value ranges from 0-100 percent and has a default setting of 25 percent, the carbohydrate intake value ranges from 0-100 percent and has a default setting of 45 percent. The American Heart Association's recommended adult “prudent diet” calls for total fat of less than 30 percent. The American Heart Association dietary guidelines comprise 5 or more servings per day of fruits and vegetables, 6 or more servings per day of whole grains, and using fat-free and low-fat milk products, fish, legumes, skinless poultry and lean meats. The American Heart Association diet further comprises use of fats and oils with 2 grams or less of saturated fat per tablespoon, such as liquid and tub margarines, canola oil and olive oil. The diet recommends the health provider balance the number of daily calories the patient consumes with the patient's caloric energy requirements. The diet limits the patient's intake of foods high in calories or low in nutrition, including foods like soft drinks and candy that have a lot of sugars, and further limit foods high in saturated fat, trans fat and/or cholesterol, such as full-fat milk products, fatty meats, tropical oils, partially hydrogenated vegetable oils and egg yolks. The American Heart Association diet requires the patient to eat less than 6 grams of salt (sodium chloride) per day (2,400 milligrams of sodium), and have no more than one alcoholic drink per day for women and no more than two for men, where one drink has no more than ½ ounce of pure alcohol. Examples of one drink are 12 oz. of beer, 4 oz. of wine, 1½ oz. of 80-proof spirits or 1 oz. of 100-proof spirits.

The Zone diet intake value for protein ranges from 0-100 percent and has a default setting of 30 percent, the carbohydrate intake value ranges from 0-100 percent and has a default setting of 40 percent. The fat intake value ranges from 0-100 percent and has a default setting of 30 percent. The Zone diet stipulated 1,500 calories per day are indeed for a calorie-restricted diet. The Zone diet comprises approximately 30 percent protein, 40 percent carbohydrate, and 30 percent fat in a calorie-restricted diet.

The Atkins diet intake value for protein ranges from 0-100 percent and has a default setting of 45 percent, the fat intake value ranges from 0-100 percent and has a default setting of 50 percent, the carbohydrate intake value ranges from 0-100 percent and has a default setting of 5 percent. 60 percent of the calories are derived from fat.

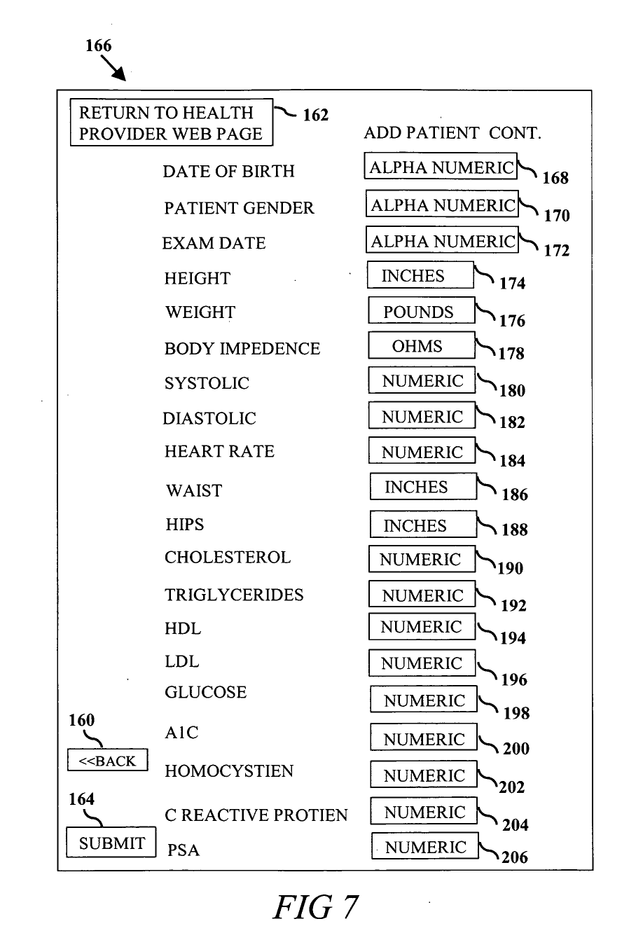

Further depicted in FIG. 6, the health provider 26 is prompted to perform the step of inputting the patient's name 122 and race 124 comprising alphanumeric characters. The health provider 26 is prompted to enter the patient's contact information 126 comprising phone number, mailing address, email address, and user name and enter the patient's password 128. The health provider is further prompted to select a retest interval 130, ranging between 1 and 12 weeks, and dietary percentages for protein content 132, fat content 134 and carbohydrates 136. Default values of the dietary percentages are displayed according to the diet category 120 selected and may be modified by the health provider 26. The health provider 26 is further prompted to answer if the patient as active 138 and if the patient 26 has email privileges 140 with the health provider and if the patient is designated a medical patient 142. The health provider 26 may enter a caloric energy deficit 40 or accept a displayed default value according to the diet category 120 selected, the diagnostic data 42, patient user profile, health risk analysis and information in stored in the relational database 32. An exercise level 144 and an activities of daily living value 146 are set from a list comprising light, medium and heavy. The health provider selects from options to designate cyber store 148 as active, use of supplements 150, and use of cyber rounds 152. The health provider 26 is further prompted to select if the patient may add and remove exercises 154 in their exercise plan, when the patient has demonstrated competence in their knowledge of exercise activities. The health provider is further prompted to enter an obesity treatment plan user name 126 supplied to the patient 24 for use in the patient login process. The health provider is prompted to designate the patient as a medical patient 142 by selecting a radio button 143, where the patient is designated as a wellness patient by default. FIG. 6 further depicts one embodiment of the invention where the health provider may select an option to go back 160 to the previously displayed web page, return to the individualized health provider web page 162 or to submit 164 the entered data, where selecting the submit option, displays a continued add new patient web page as depicted in FIG. 7.

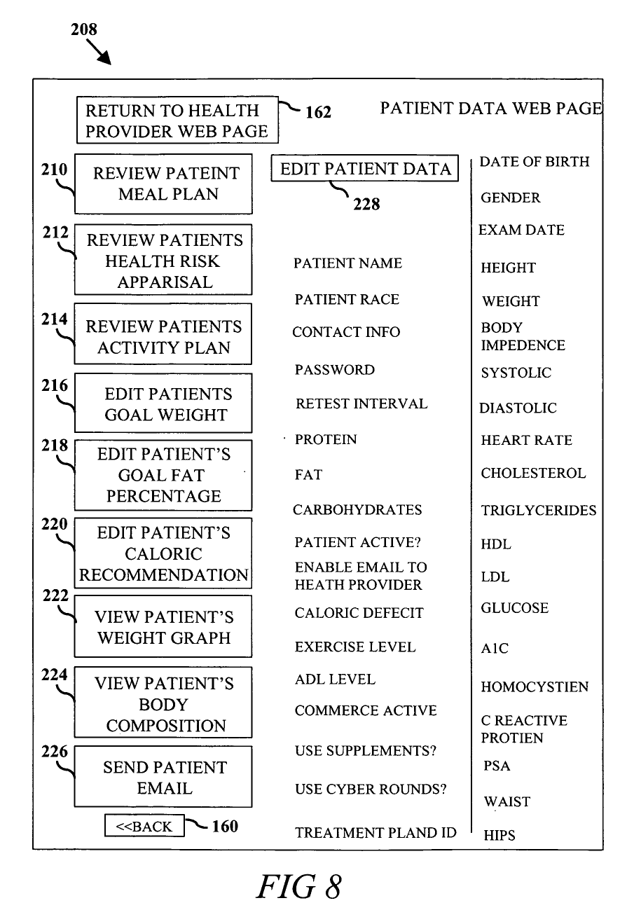

In FIG. 7, the continued add new patient web page 166 further prompts the health provider to enter patient data comprising, the patient's 24 date of birth 168, gender 170, examination date 172, patient height 174, patient weight 176, body impedance 178, systolic blood pressure 180, diastolic blood pressure 182, heart rate 184, waist size 186, and hip size 188. Where the patient is designated as a medical patient 142, the health provider 26 is prompted to input values for cholesterol 190, triglycerides 192, high-density lipids 194, low-density lipids 196, glucose 198, A1C 200, homocystien 202, C-reactive protein 204, and protein specific antigen (PSA) 206. The health provider may select an option to go back 160 to the previously displayed web page, or an option to return to the individualized health provider web page 162. The input data is entered to the computer program by selecting the submit 130 option, whereby displaying a patient data web page 174 as one embodiment is depicted in FIG. 8.

The patient data web page 208 depicted in FIG. 8 comprises the data and information entered by the health provider 26 for newly added patients and for active and inactive patients. The patient data web page 208 further comprises the menu options review patient's meal plan 210, review patent's health risk analysis 212, review patent's activity plan 214, edit patent's goal weight 216, edit patient's goal fat percentages 218, edit patient's caloric recommendation 220, view patient's weight graph 222, view patient's body composition 224, send patient email 226, return to health provider web page 162, go back 160 to the previous web page, and edit the patient's data 228.

The step of selecting the review the patient's meal plan option 210 from the patient data web page 208 depicted in FIG. 8, displays an edit patient meal plan web page 230 having options enabling the health provider to edit a patient's meal plan, where the meals comprise breakfast, morning snack, lunch, afternoon snack, and dinner. Further displayed are options enabling the health provider to review protein, starch, vegetable, fruit, fat, and dairy information.

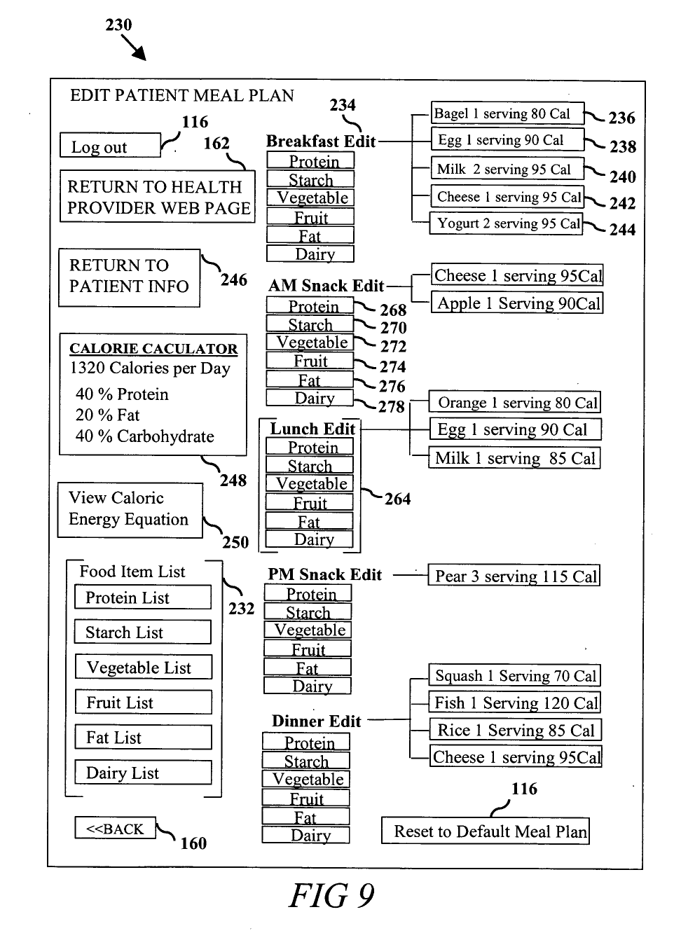

FIG. 9 depicts one embodiment of an edit meal plan web page 230 having sample data for illustrative purposes depicting the steps of creating a patient's individualized meal plan 60, derived according to the patient user profile, health provider instructions, stored obesity treatment history data and expert review board information.

The health provider 26 performs the steps of editing the patient's individualized meal plan 60, wherein the patient's individualized caloric energy equation 38 and caloric deficit 40 are automatically updated by the computer program instructions to reflect the changes. The meal plan 60 comprises daily meals having specified calories per day for protein, carbohydrates and fat. A food item list 232 comprising food item options for protein, starch, vegetable, fruit, fat and dairy is displayed, wherein selecting a food list item option displays a web page having information related to the selected food item. The food item information comprises serving size, nutrition, preparation and use, and sample recipes (not shown). Further depicted, for example, are five food items in the breakfast meal edit list 234 comprising: a bagel 236, an egg 238, 2-servings of milk 240, 1-serving of cheese 242 and 2-servings of yogurt 244. Each food item in a meal edit list 234 is an option for displaying an edit food item web page for editing the selected food item in the individualized meal plan 60. The edit meal plan web page 200 further comprises options to log out 116, return to health provider web page 162, return to patient data web page 246, calorie calculator 248, and view patient's caloric energy equation 250, and go back to previous web page 160.

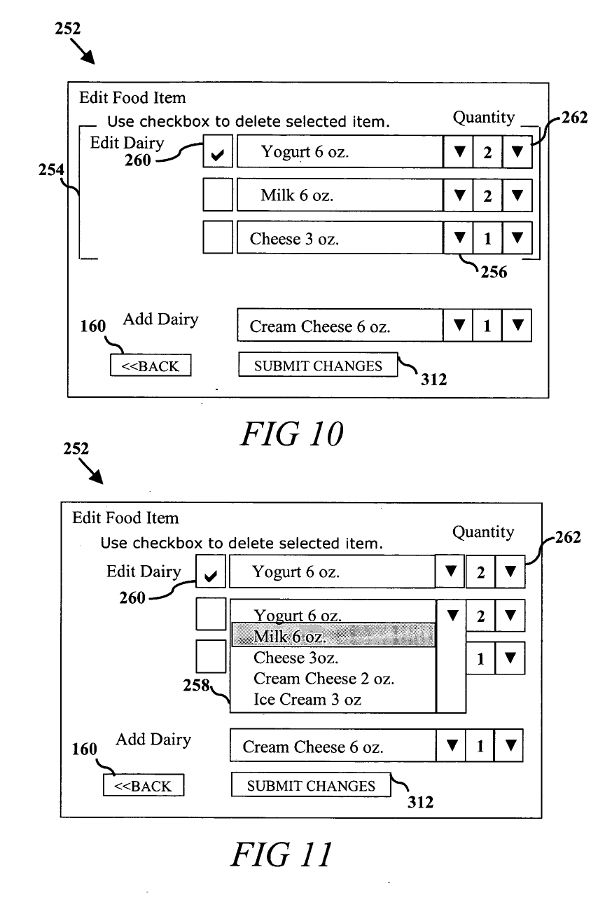

FIGS. 10 and 11 depict a sample edit food item web page 252, according to one embodiment of the invention, where, for example, the health provider 26 selects the yogurt food item option 244 from the breakfast food item list 234 in FIG. 9. The edit food item web page 252 displays a list of the dairy food items 254 in the patient's breakfast meal edit list 234. Depicted in FIG. 9, the breakfast dairy food items comprise yogurt 244, milk 240 and cheese 242 and are displayed to the health provider 26 in the edit food item web page 252 of FIG. 10. The health provider 26 may select from other dairy food items in the dairy food item list (not shown) stored in the secure relational database 32, by selecting a food item menu option 256 for displaying the dairy food item list, where in this example the menu option is a drop-down menu 258 as depicted in FIG. 11, and it is understood that other menu and selection methods can be used without detracting from the spirit of the invention. Further depicted in FIGS. 10 and 11, are options to delete food items from the food item list 254, where the health provider 26 selects a check box delete option 260 to indicate a food item to delete upon selecting a submit changes option. The health provider selects a serving number option 262 to assign a number of servings to a food item. Further depicted in FIGS. 10 and 11 is an option to go back 160 to the previous web page. This method of editing dairy food items in the breakfast meal plan may be used for other food items such as starch, protein vegetable, fruit, fat and supplements, and is used for other meals such as AM snack, lunch, PM snack and dinner.

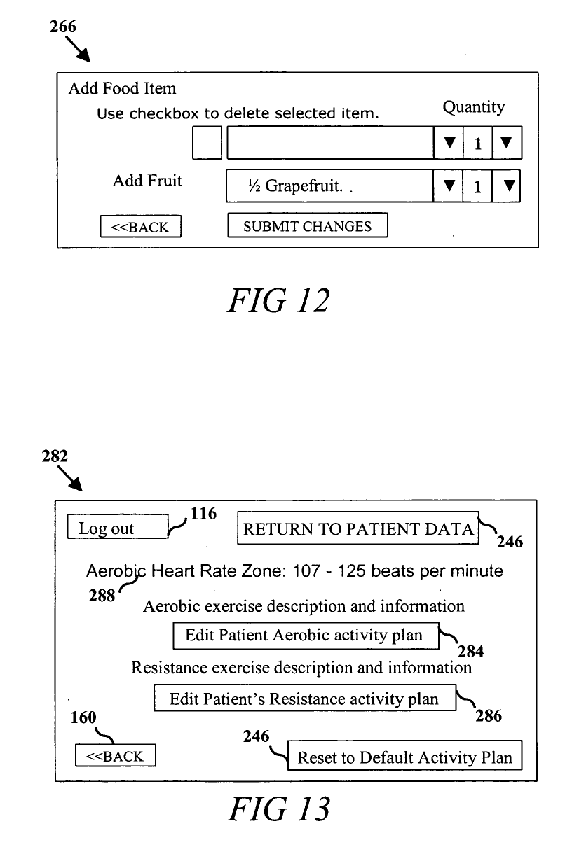

Referring again to FIG. 9, the health provider may add a food category to an individualized meal plan 60 by selecting an add food category option from a food category list 264 depicted below each meal, where an add food category web page 266 is displayed for adding a food category to an individualized meal plan 60. The add food category options depicted in FIG. 9 comprise protein 268, starch 270, vegetable 272, fruit 274, fat 276, and dairy 278. FIG. 12 depicts a sample add food category web page 266 for adding a fruit category 274, of FIG. 10, to the patient's breakfast menu depicted in the edit meal plan web page 230 of FIG. 9. Default food items automatically appear for breakfast, morning snack, lunch, evening snack and dinner meals according to the diet category selected, the patient user profile, health provider instruction, diagnostic data and stored obesity treatment history data and expert review board information. The health provider 26 may substitute, add and delete food items in the meals while remaining within their caloric recommendations to the patient 24 according to the individualized caloric energy equation 38 described above. The default meal plan food items may be reset when the health provider 26 selects a reset to default food items option 280.

The step of selecting the option to view the patient's caloric energy equation 250, of FIG. 9, displays a current caloric energy equation web page (not shown) having the patient's current basal metabolic rate 68, specific dynamic action of foods 70, activities of daily living 72, calories burned by exercise 74, caloric energy requirements 74, caloric deficit for weight loss 78, and the caloric recommendation 78.

The step of selecting the a calorie calculator option 248, displays a calorie calculator web page (not shown) having the current daily calorie intake value according to the food items selected for the individualized meal plan 60. The calorie calculator web page may be set to alert the health provider when an added food item causes caloric recommendation 78 to be exceeded. In the event a health provider 26 adds food items that exceed caloric recommendation 78, the computer program 30 displays an alarm web page (not shown) informing the health provider 26 that the caloric recommendation 78 is being exceeded, where the health provider 26 has the option to accept or override the caloric recommendation value 78.

Referring again to FIG. 8, the step of selecting the option to review a patient's health risk analysis 212 displays a health risk analysis web page (not shown) having patient information comprising overall health risk profiles according to the patient user profile, diagnostic data 42, health provider instructions, stored obesity treatment history data 54 and expert review board information 52.

The health risk analysis web page (not shown) displays to the health provider 26, the patient's health risks in terms of a percentage degree of risk or low medium and high degrees of risk according to the patient user profile, diagnostic data 42, health provider instructions, information input by the patient, stored obesity treatment history data 54 and expert review board information 52. A health risk age is provided as an estimation of the patient's current biological age and achievable biological age. A body composition profile is displayed comprising data for percent body fat, percent lean body mass and an ideal body fat range according to the patient's age, sex, race, heredity and body morph type.

In one embodiment or the current invention, when the patient diagnostic data 42 includes blood analysis, the optional configuration of the invention displays blood analysis graphs comprising risk levels of cholesterol, triglycerides, high-density lipid protein, low-density lipid protein, diabetes, and glucose.

A coronary risk profile (not shown) comprises bar graphs to show the individual factors affecting the patient's 24 risks for heart rate, systolic blood pressure, diastolic blood pressure, and coronary heart disease, where including blood analysis values further defines the coronary risk profile.

A nutrition risk profile (not shown) and an exercise risk profile (not shown) are displayed according to the patient user profile, diagnostic data 42, information input by the patient, health provider instructions, stored obesity treatment history data 54 and expert review board information 52. Non-controllable risk factor information is based on hereditary indicators passed on to the patient from their direct family. Non-controllable risk factor information (not shown) displays the patient's 24 risk of certain conditions based on family history including a family diabetes risk profile, family strokes/vascular disease profile and family cancer risk profile. A lifestyle risk analysis (not shown) is displayed having information showing the impact of various lifestyle choices on the patient's health comprising, personal health choices, alcohol and drug use choices, tobacco use choices exercise choices and a personal safety profile. A hypertension risk profile (not shown) is displayed comprising information for systolic blood pressure, diastolic blood pressure, mean arterial, nutrition profile, exercise profile, and body composition report. An arthritis risk profile (not shown) is displayed comprising age, nutrition, exercise, and body composition information. An osteoporosis risk profile (not shown) is displayed comprising, age, nutrition, and exercise profiles. A nutrition profile (not shown) is displayed based on the patient's body composition and exercise program. A cancer risk profile (not shown) is displayed according to the results of the health risk analysis.

From the patient data web page 208 depicted in FIG. 8, selecting the option to review the patient's activity plan 214 displays a patient activity plan web page 282, depicted in FIG. 13, having options enabling the health provider 26 to edit the selected patient's 24 individualized activity plan 62 comprising options to edit an aerobic activity 284 plan and edit resistance activity plan 286. Aerobic activity information (not shown) is displayed including optimizing body composition and overall levels of fitness. Other information (not shown) includes warming-up and stretching techniques before each exercise session, and how to maximize results while reducing risk of injury. Resistance activity information (not shown) is displayed including resistance exercise sets, repetitions and ranges of repetitions, range of motion, lifting weight adjustment, aerobic training zone, target zone and use of energy. As depicted in FIG. 13 the patient activity plan web page further displays the patient's 24 aerobic heart rate zone 288 in beats per minute, where the value is according to the patient user profile, diagnostic data 42, health provider instructions, stored obesity treatment history data 54 and expert review board information 52. Additionally, the health provider 26 may select an option to reset to default activity plan 290 values to return the activity plan parameters in to predetermined default values according to the patient user profile, diagnostic data 42, health provider instructions, stored obesity treatment history data 54 and expert review board information 52. Further displayed to the health provider 26, and depicted in FIG. 13, are options to return to the patient data web page 246, or go back 160 to the previous web page.

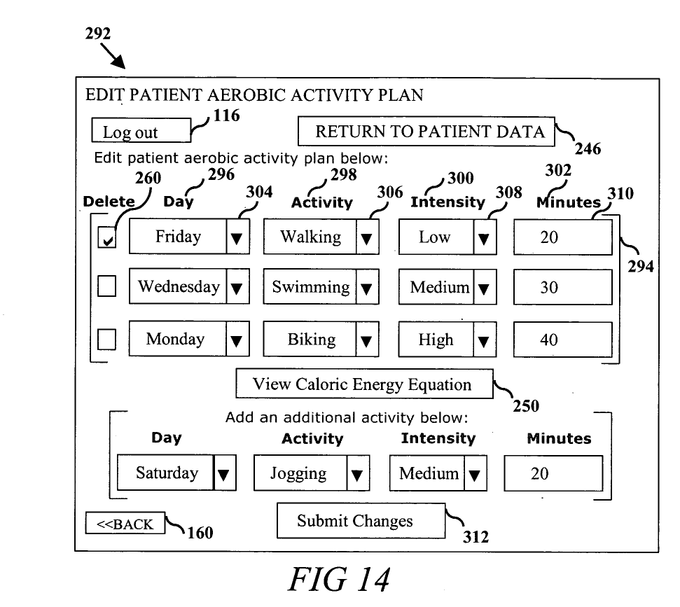

The step of selecting the option to edit the patient's aerobic activity plan 284 displays one embodiment of an edit patient aerobic activity plan web page 292, depicted in FIG. 14, having an aerobic activity list 294 and options enabling the health provider 26 to edit, add and delete aerobic activity exercise in the individualized activity plan 62. As depicted, the aerobic activity exercise comprises an aerobic activity day 296, an aerobic activity 298, an aerobic activity intensity 300 and aerobic activity duration 302. To edit an aerobic activity exercise, the health provider 26 selects a desired day 296 from a day list option 304, an aerobic activity from an activity list option 306, an intensity value from an intensity list option 308 and a duration value from a duration list option 310, and then selecting submit changes option 312. A day list comprises days of the week, and an aerobic activity list comprises walking, jogging, running, cycling, swimming, stair climbing, aerobics, cross country skiing, rowing, racquet sports, and circuit training. The intensity list comprises low medium and high, and the duration is a numeric value input by the health provider. The health provider 26 deletes a desired aerobic activity, by selecting a check box delete option 260 to indicate an aerobic activity event to delete upon selecting the submit changes option 312. The edit aerobic activity plan web page 292 is predetermined in the add patient web page 118 by the health provider 26 to enable or disable the patient's 24 ability to add and delete exercises from the activity plan 62. The health provider 26 may select an option to review the patient's individualized caloric energy equation 250 as modifications are made to the individualized activity plan 62. The step of selecting the option to view the patient's individualized caloric energy equation 250 displays a caloric energy equation web page (not shown), as discussed above, and is automatically updated according to any aerobic activity plan modifications by the health provider.

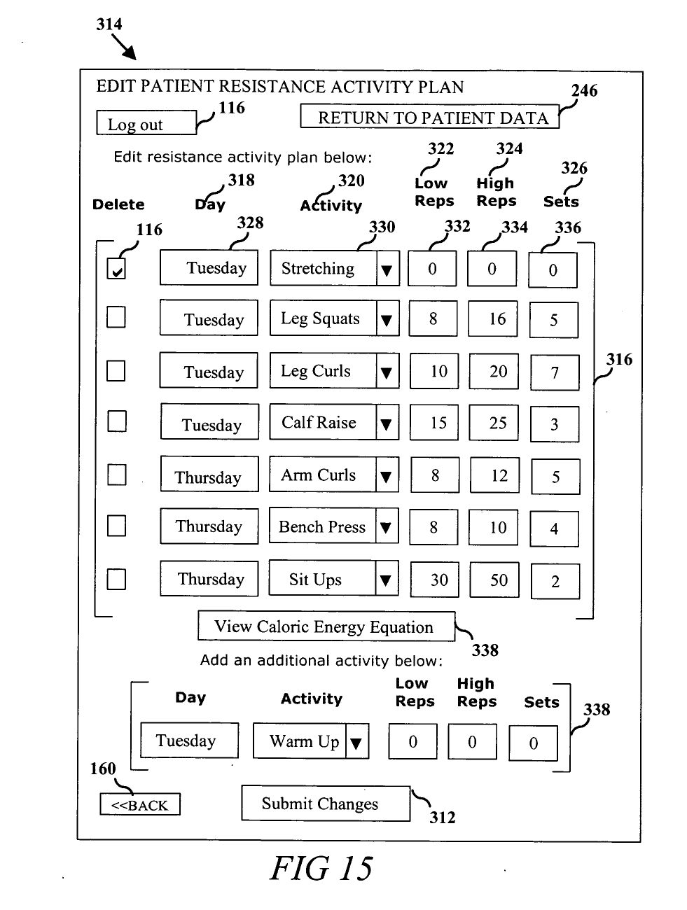

The step of selecting the option to edit the patient's resistance activity plan 286 from the patient activity plan web page 282 displays an edit patient resistance activity plan web page 314, depicted in FIG. 15, having a resistance activity exercise list 316, and options enabling the health provider 26 to add and delete resistance activity exercises in the individualized activity plan 50. As depicted, the resistance activity event comprises a resistance activity day 318, a resistance activity 320, a high repetition value 322, a low repetition value 324 and a number of sets 326. To edit a resistance exercise, the health provider 26 selects a desired day 318 from a day list option 328, a resistance activity from a resistance activity list option 330, and inputs low repletion 332, high repetition 334, and number of sets 336 values. The day list 328 comprises days of the week. The resistance activity list 330 comprises overhead triceps extension, squats, roman chair sit-ups, warm up, reverse crunches, low back machine, nautilus torso, hip adductor, leg twist, side twist, shrugs, test, stretching, hanging leg raises, crunches, nautilus pull over, forearm, cool down, dumbbell flat fly's, laying leg raises, nautilus compound, wrist curl, and seated calf raise. The health provider 26 may add a resistance activity exercise to the individualized activity plan 62 by selecting a day 318, a resistance activity 320 and inputting a low repletion 322 numeric value, a high repetition 324 numeric value, and a number of sets 326, from the add additional activity prompts 338 and selecting the submit changes option as depicted in FIG. 15. The health provider 26 may delete a desired resistance activity exercise, where the health provider selects check box delete option 260 to indicate a resistance activity exercise to be deleted upon selecting the submit option. The edit resistance activity plan further comprises an option to review the patient's individualized caloric energy equation 250, where the caloric energy equation is automatically updated according to any resistance activity plan modifications made by the health provider 26.

From the patient data web page depicted in FIG. 8, the step of selecting the option to edit this patient's goal weight 216 displays a goal weight web page (not shown) having the patient's current goal weight and a prompt to enter a new goal weight range having a low goal weight and high goal weight value.

The step of selecting the option to edit the patient's goal fat percentages 218 displays a web page (not shown) having the patient's current goal fat percentage range comprising a low value and a high value and a prompt to enter a new goal fat percentage range for the patient.

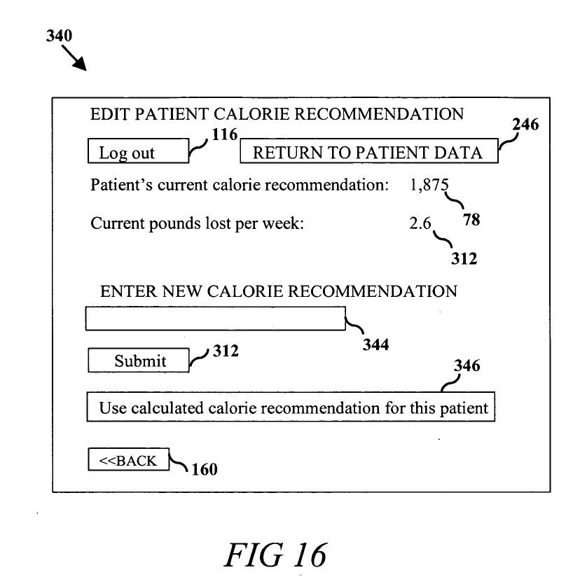

Further, from the patient data web page depicted in FIG. 8, selecting the option to edit the patient's caloric recommendation 220 displays an edit caloric recommendation web page 340 depicted in FIG. 16. The edit caloric recommendation web page 340 displays the patient's current caloric recommendation 78, the patient's 24 calculated current pounds lost per week 342 a prompt to enter a new caloric recommendation 344, and an option to use a calculated caloric recommendation 346 according to the patient user profile, diagnostic data 42, health provider instructions, stored obesity treatment history data 54 and expert review board information 52. The health provider 26 may make specific caloric intake recommendations for the caloric intake for a patient 24, whereby affecting the individualized caloric deficit 40 from the individualized caloric energy equation 38. The caloric value input here effects the patient individualized meal plan 60 caloric values, where the caloric content of the meal items and serving sizes are automatically adjusted to match the new caloric value.

From the patient data web page 208 depicted in FIG. 8, the step of selecting the option to view the patient's weight graph 222 displays a weight graph web page (not shown) having a graph according to the daily weight measurements entered by the patient 24. The scale weight is not the primary focus of the current invention, it can be useful and motivational, where reduced percent body fat readings measured by the health provider is an important aspect of the invention.

The step of selecting the option to view this patient's body composition measurements 224 displays a body composition web page (not shown) having the patient's 24 body composition data 46 comprising measured lean body mass, percentage of lean body mass, lean body mass to fat ratio, total body water, optimal lean body mass to fat ratio, weight of body fat, desired range of percent body fat, percentage of body fat, and fat free mass comprising muscles, body fluid, connective tissue and bones. Further displayed is the patient's 24 current status, and weight composition goals comprising a percent body fat, a percent lean mass, percent excess fat and an Ideal body fat range.

Referring again to FIG. 5, the step of selecting the view existing patients option 84 from the individualized health provider web page 80 depicted in FIG. 5, displays a patient name list (not shown) where each patient name in the list is an option to display the selected patient's data when selected. The step of selecting a patient name from the patient name list retrieves patient information stored in the data storage system and displays an individualized patient data web page 208 as depicted in FIG. 8, having options enabling the health provider 26 to evaluate and modify the patient's 24 individualized treatment plan as described above.

The step of selecting the patient search option 86 from the health provider web page 80 in FIG. 5 displays a patient search web page (not shown) having a prompt for the health provider 26 to input the desired patient's 24 last name, first name, or obesity treatment plan username and select a search option, where search results display a list of patients 24 that match patient names or user names. Each name in the search results list is an option to display an individualized patient data web page 208 for the selected patient name. The step of selecting a patient name from the patient name list retrieves patient information stored in the relational data storage system 34 and displays options enabling the health provider 26 to evaluate and modify the patient's treatment plan as described above and as depicted in FIG. 8.

The step of selecting the view inactive patient list option from the health provider web page 80 in FIG. 5 displays an inactive patient list web page (not shown) that enables the health provider 26 to view a list of the health provider's patents 24 who are not currently active in an individualized obesity treatment plan. Each displayed patent name in the inactive patent list is a menu option to display the selected patient's 24 information and treatment history 54. The step of selecting an inactive patient name from the inactive patient name list retrieves the selected inactive patient information stored in the data storage system 34 and displays options enabling the health provider 26 to evaluate the inactive patient's treatment plan history 54. These options comprise review patient meal plan 60, health risk analysis 56, activity plan 62, goal weight history, goal fat percentages history, caloric recommendation history, weight graph, body composition history, and emails sent to the patient 24.

The step of selecting the enter doctor's chat room option 90 from the health provider web page 80, displays health provider chat room web page (not shown) prompting the health provider 26 to enter their username and select a submit option. The computer program verifies the input information and a doctor's chat room web page is displayed having a health provider networking and exchange board and a subject list of previously posted health provider messages, where the chat subjects are options enabling the health provider to review the message details when selected. Additionally, the health provider 26 may select an option enabling the health provider 26 to post messages on a message board for exchanging information among colleagues. The health provider 26 selects an option to compose a message and is prompted to type a subject in a health provider chat room subject line, and type a message in a health provider chat room message prompt, then select a post message option to post the message on a health provider community web-based message board.

FIG. 5 depicts other options to enable the health provider to perform tasks for treating obese patients, such as selecting the scientific overview of plan option 92 on the health provider web page 80 gives the health provider 26 access to detailed information for the health risk analysis 56, body composition analysis and aerobic activities (not shown), so the health provider is empowered to make informed decisions throughout any patient treatment plan.

The step of selecting the modify patient greeting option 94 enables the health provider 26 to review and modify a patient introduction letter (not shown) for welcoming the patient 24 to the individualized obesity treatment plan and provide a brief overview of what to expect throughout the plan.

The step of selecting view cyber store option 96 displays additional products and services available to the patient that are useful for weight reduction, health and fitness (not shown). The health provider 26 may add products and services to the cyber store web page by selecting an add commerce option (not shown).

The step of selecting the email patient option 98 displays a patient name list, where each name in the list is an option to send an email to a selected name, and prompts the health provider 26 to select a patent 24 to email, whereby an email page (not shown) is displayed for the health provider 26 to create and send email information.

The health provider 26 may select an option to send broadcast email 100 to the patients 24 in their active and inactive patient lists, where selecting the send broadcast email option 100 displays a prompt for the health provider 26 to enter a subject into a subject window and enter a message into a message window (not shown). The health provider 26 may then select an option to send the message, where the message will be sent to all active and inactive patients on the health provider's list (not shown).

The step of selecting the revenue and billing options 102 option displays a revenue and billing web page (not shown) that guides the health provider 26 through a step-by-step process of billing for services rendered through the individualized obesity treatment plan program as established in the current procedural terminology (CPT), where a CPT code is required in all medical insurance billing procedures.

The step of selecting a contact treatment plan provider option 104 enables the health provider 26 to contact the treatment plan provider regarding issues or comments (not shown).

The step of selecting the review medical literature option 106 displays a library of medical journal and medical institution internet links (not shown) for the health provider's 26 review, where this information is updated by the expert review board.

The step of selecting the upload doctor photo option 108 enables the health provider to add their photo to the patients individualized obesity treatment plan (not shown).

The step of selecting log out 116 option enables the health provider to exit from the treatment plan web site.

The step of selecting the add supplements option 110 from the health provider web page 80 enables the health provider to add new dietary supplements to the meal item list using an add supplement web page (not shown). A supplement is a pre-packaged nutritional food item having USDA labeling comprising total calories per serving, calories from fat per serving, calories from protein per serving, and calories from carbohydrates per serving. An add new supplement web page prompts the health provider 26 to enter a new supplement name, the grams of protein per serving, the grams of carbohydrate per serving and the grams of fat per serving, then select an option to update meal items, whereby the new supplement is added to the health provider's food list. The health provider 26 may then selectively add the new supplement to any of the patient's individualized meal plan 60 using the add food item method as described above. Further displayed to the health provider 26 on the add new supplement web page are options for editing and deleting a new supplement (not shown).

Further depicted in the health provider web page 80 of FIG. 5 is a cyber rounds patient list 112, where each patient name in the list is an option to display the selected patient's data web page, meal plan web page, activity plan web page and individualized caloric energy equation 66, and treatment ledger web page for that patient (not shown). The health provider 26 is automatically prompted to review a patient's treatment plan according to a predetermined periodicity.

Additionally depicted in FIG. 5 is a patient diagnostic data list 114, where each patient name in the list is an option to notify the patient 24 that they need to schedule their next visit with the health provider 26. The health provider 26 is automatically prompted to notify the patient 24 according to a predetermined periodicity.

Discussing now the patient aspects of the current invention. As depicted in FIG. 2, the patient 24 uses the patient terminal 14 to access the internet 18 and the obesity treatment plan computer. In one embodiment of the invention, a treatment plan entry web page (not shown) having a patient option, a health provider option, and a tour option provides an access portal. The patient 24 selects the patient option to display a patient log in web page (not shown) prompting the patient 24 to enter their username and password and select an option to log in. The information is verified and the patient 24 is granted access to an individualized patient web page (not shown), where a new patient accessing the patient web page for the first time is provided a use agreement web page, and an existing patient web page displays returns the patient to their last location in the treatment plan.

The use agreement web page (not shown) comprises a terms of use statement and options to accept or decline the terms of use. The step of selecting the option to decline the terms of use, returns the display to the enter treatment plan web page (not shown), and selecting the option to access the terms of the treatment plan use agreement displays the health risk analysis questionnaire web page (not shown), having the welcome and introduction message from the health provider 26 discussed above, and an option to start a patient health risk analysis questionnaire 50. The results from the health risk analysis 56 are correlated with diagnostic data 42, expert review board data 52, treatment history data 54 to derive an individualized caloric energy equation 38, an individualized meal plan 60, an individualized activity plan 62, patient education curriculum 62, and an individualized caloric deficit 40, as depicted in FIG. 3.

A health risk analysis 56 is generated from the computer program 30 correlating data comprising information from the health risk analysis questionnaire 50, the patient's diagnostic data 42, obesity treatment statistical information provided by the expert review board 52 and historical treatment data 54 within the individualized obesity treatment plan computer relational database 32. Information provided by the patient performing the steps to complete a health risk analysis questionnaire 50 is correlated and health risk analysis results are displayed on a health risk analysis web page (not shown).

The health risk analysis results (not shown) comprise a health risk overview, health risk age, body composition, coronary risk profile, cancer risk profile, nutrition profile, exercise profile, non-controllable risk profile, lifestyle analysis, personal health and safety profile, diabetes risk profile, hypertension risk profile, arthritis risk profile, and osteoporosis risk profile. The health risk overview comprises a overall health risk according to information from the health risk analysis questionnaire, the diagnostic data from the health provider 26, obesity treatment statistical information provided by the expert review board 52 and historical treatment data 54 within the individualized obesity treatment plan computer data base. The displayed health risk age comprises the patient's current age, adjusted health risk age and achievable risk age, where the health risk age is an estimation of the body's current biological age.

The body composition profile (not shown) comprises percent body fat, percent lean body mass and the ideal range body fat, where a graph is displayed to the patient 24 indicating the current body composition status compared to an achievable status. The patient 24 is provided body composition intervention factors (not shown) to improve their current body composition statistics comprising fat consumption, convenience foods and daily meals, where the body composition statistics comprise measured values for percent body fat, percent lean body mass, and an ideal range of lean body mass.

The coronary risk profile (not shown) comprises correlating and displaying values for the patient's 24 hereditary factors, cholesterol, triglycerides, lipo-proteins, systolic and diastolic blood pressures, heart rate, alcohol and tobacco use, and fat content in diets where a graph is displayed to the patient indicating the current coronary risk status compared to an achievable status. The patient 24 is provided coronary risk intervention factors (not shown) comprising family history of coronary heart disease, strokes, exercise and carbohydrate consumption.

The cancer risk profile (not shown) is derived from information comprising family history, nutritional habits, age and physical activity where a graph is displayed to the patient indicating the current cancer risk status compared to an achievable status. The patient 24 is provided cancer risk intervention factors (not shown) comprising, family history of cancer, exercise frequency, fat consumption, cereal grain products, and fruit consumption.

The nutrition profile (not shown) comprises graph displayed to the patient 24 indicating the current nutritional status compared to an achievable status, and provides intervention factors comprising family history of coronary heart disease, family history of strokes, exercise frequency, and carbohydrate consumption. Intervention factors comprising nutrition education, food preparation, food label reading and food composition are provided.

The exercise profile (not shown) comprises a graph displayed to the patient 24 indicating the current exercise status compared to an achievable status, and intervention factors comprising exercise frequency, exercise type, warm-up and cool-down information, weight training information.

The non-controllable risk profile (not shown) comprises a graph indicating the non-controllable risk status compared to statistical values for patients having similar histories, according to the patient's family history indicators comprising coronary heart disease, diabetes, stroke and vascular disease, and cancer. Intervention factors (not shown) are provided to educate the patient 24 about their non-controllable risks and the effect their personal choices have on these risks.

The lifestyle analysis profile (not shown) comprises a graph indicating a current health status compared to an achievable personal health status based on alcohol use, tobacco use, and exercise and nutrition habits. Intervention factors (not shown) are provided to educate the patient 24 about their lifestyle risks and the effect their personal choices have on these risks.

The personal health and safety profile (not shown) comprises a graph indicating a current health and safety status compared to an achievable status, and intervention factors comprising preventive actions such as dental visits, installing smoke detectors and wearing seat belts. Intervention factors (not shown) are provided to educate the patient 24 about their safety risks and the effect their personal choices have on these risks.

In one embodiment of the current invention, where the patient user profile further comprises blood data 48, risk profiles (not shown) for diabetes, hypertension, arthritis, and osteoporosis are generated and displayed. The diabetes risk profile (not shown) comprises graphs indicating current risk status versus achievable status for diabetes, glucose, nutrition, exercise, body composition and a waist to hip ratio as they apply to the diabetes health risk profile. The patient 24 is provided intervention factors comprising family history of diabetes mellitus, exercise frequency, carbohydrate and fat consumption.

The hypertension risk profile (not shown) comprises graphs comparing the patient's 24 current status to an achievable status for hypertension risk, systolic blood pressure, diastolic blood pressure, homosystiene, lipid peroxidase, high-density lipid protein, low-density lipid protein, mean arterial pressure, nutrition, exercise and body composition. Intervention factors (not shown) for improving the patient's 24 hypertension risk are provided comprising exercise frequency, cereal grain products, salt intake, water consumption, and caffeine intake.

The arthritis risk profile (not shown) comprises graphs indicating the current risk status versus achievable status for arthritis, age, nutrition, exercise and body composition. Intervention factors (not shown) comprising exercise frequency, exercise type, warm-up and cool-down information, carbohydrate and fat consumption are provided for improving the patient's arthritis risk.

The osteoporosis profile (not shown) comprises graphs indicating the patient's current risk status versus achievable status for osteoporosis, age, nutrition and exercise as they apply to the osteoporosis profile. The patient 24 is provided intervention factors (not shown) comprising exercise frequency, exercise type, warm-up and cool-down information, weight training and cereal and grain products.

First time patients 24 who are new, review their health risk analysis web page (not shown) to completion to display an option for beginning a multi-week lesson plan. The step of selecting the option to begin the multi-week lesson plan displays an individualized patient lesson planner web page 348 having multi-week course outline list options to enable obesity treatment.

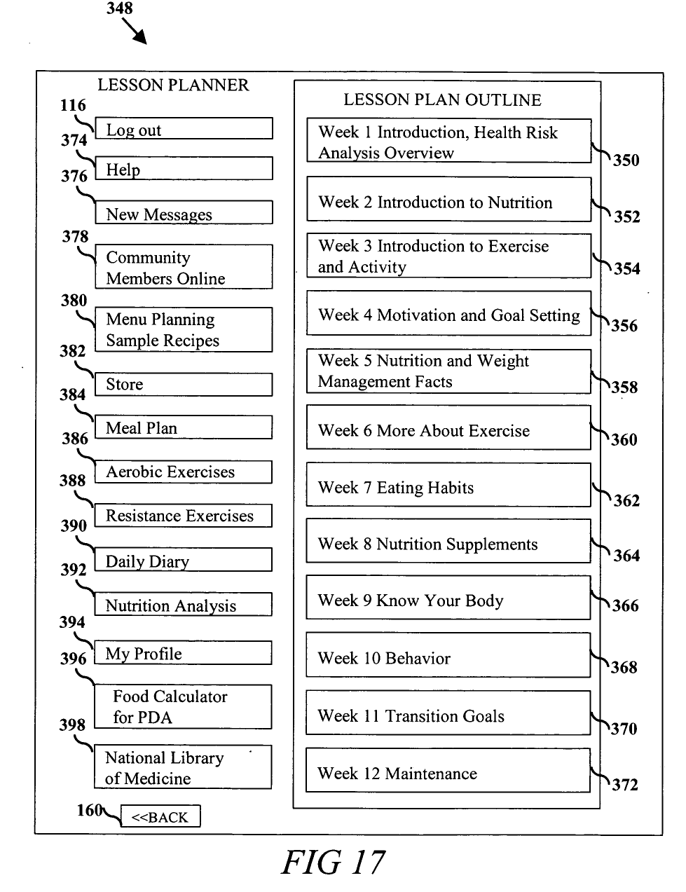

One embodiment of an individualized multi-week lesson planner web page 348 is depicted in FIG. 17. The lesson planner web page 348 displays lesson plan options comprising an introduction and health risk analysis overview 350, introduction to nutrition 352, introduction to exercise and activity 354, motivation and goal setting 356, nutrition and weight management facts 358, more about exercise 360, eating habits 362, nutrition supplements 364, know your body 366, behavior 368, transition goals 370, and maintenance 372. In one embodiment, the lesson plan duration is one week. A weekly lesson plan comprises setting goals, displaying daily lessons and review quizzes to the patient for improving their nutrition, fitness and healthful lifestyle awareness.

The daily lesson comprises displaying information (not shown) for nutrition, fitness and health, and providing a lesson plan review quiz. In the lesson plan review quiz (not shown), the patient is prompted to select from a list of possible answers and submit the completed quiz to display quiz results, where the quiz reaffirms the lesson plan and promotes goal achievement by the patient 24. The patient 24 is prompted to input their weight at the end of each day for display in a weight profile (not shown). The patient 24 is further prompted to complete a starvation response query (not shown) at the end of each day, where the patient 24 inputs their feeling of daily hunger by selecting from an option list of low, medium and high. The patient lesson plan quiz results, weight and starvation response information are input to the computer program 34 for display to and review by the health provider 26 to monitor the individualized obesity treatment plan, where the starvation response information is correlated with the individualized caloric energy equation 38.

The steps of completing each weekly lesson plan displays a compliance log web page (not shown) prompting the patient 24 to input their compliance in meeting the treatment plan goals. The lesson plan goals comprise the patient 24 eating meals on schedule, how much the patient 24 was satisfied after eating, how hungry was the patient 24 during the day, if the patient 24 ate all of their food, did the patient 24 followed the meal category fat content guidelines, if the patient 24 consumed at least 8 (8 oz.) glasses of water each day, if the patient 24 completed their exercise for the week, did the patient 24 maintained their aerobic heart rate during exercise, if the patient 24 used techniques of warm-up before and cool down after exercising, the patient 24 performed adequate stretching, did the patient 24 review their short-term goals, and if the patient 24 did something special for their self this week.

The steps of operating a compliance log web page comprise inputting a number to a lesson plan goal prompt, representing the level of success the patient 24 had in complying with the treatment plan goals, between 1 and 10, where inputting a 1 indicates the patient was not compliant and a 10 perfect compliance in attaining a goal. The compliance information is automatically input to the computer program 30 and correlated to create a list of suggested adjustments for the individualized caloric deficit 40, individualized meal plans 58 and individualized activity plan 62, and individualized patient education 62 for ensuring the patient 24 does not enter the starvation response threshold. The adjustments are displayed to the health provider 26 in a treatment plan adjustments ledger web page (not shown).

The treatment plan adjustments ledger web page (not shown) displays adjustments suggested for the individualized caloric deficit 40, individualized meal plan 60, individualized activity plan 62, and individualized patient education 62 of the patient 24. The health provider 26 reviews the suggested adjustments to accept, reject or make further adjustments, if necessary, where the approved changes are for display to and use by the patient.

As a patient 24 completes each lesson plan, the lesson planner web page 348 displays the next individualized lesson plan option for the patient to select and complete, where FIG. 17 depicts one embodiment of a lesson plan web page completed by a patient through 12-weeks. The patient 24 may review any previously completed lesson plan by selecting the desired lesson plan option.

The step of selecting the introduction and health risk analysis overview 350 lesson plan option displays an introduction web page (not shown) comprising a review of diagnostic data including the patient's 24 height, weight, resting pulse rate, blood pressure, body composition analysis and certain blood laboratory values where applicable. A projected weight loss graph (not shown), based on the individualized multi-week program provided to the patient 24 by health provider 26 is displayed. Further displayed is the patient's 24 starting weight and the goal weight at the end of their multi-week treatment plan, and a value for the average weight lost per week (not shown). Additionally displayed are activities and assignments for each week, comprising a review of the diagnostic data and projected weight loss, a review of health risk analysis, an adjusted health risk age, and a body composition profile (not shown). The health risk analysis web page (not shown) displays a review of profiles for coronary risk, cancer risk and hypertension risk, arthritis risk and osteoporosis risk, and a review of nutrition, exercise, non-controllable risk and personal health & safety. A review quiz is displayed, where the patient is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the introduction and health risk analysis overview lesson plan 350, where the patient 24 is prompted to indicate their compliance with the treatment plan aspects and enter their body weight as described above.

The step of selecting the introduction to nutrition lesson plan 352 option displays a nutrition web page (not shown) comprising an introduction to nutrition, and information on reading a food label, healthful eating and menu planning, how successful dieters keep weight off, fat substitutes and carbohydrates. Information is displayed comprising body composition, exercise and nutrition. Additionally, an individualized food exchange chart (not shown) is presented and defined such that the patient 24 is provided clear parameters of food quantities and types that may be interchanged to enable meal varieties, yet remain within the individualized prescription boundaries regarding total calories, protein, carbohydrate and fat contents. A review quiz is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the introduction to nutrition lesson plan 352, where the patient 24 is prompted to indicate their compliance with the treatment plan aspects and enter their body weight as described above.

The step of selecting the introduction to exercise and activity 354 lesson plan option displays an exercise and activity web page (not shown) comprising the role of exercise, aerobic exercise basics, introduction to resistance training, building muscle and bone, and setting goals. Exercise and training information is provided to the patient 24 comprising walking, cycling, rowing, swimming, jogging, running, stair climbing, weight training and cross country skiing among others. Exercises, exercise times and, exercise intensities are set for the patient 24 by the health provider using the means described above. Information on the ramifications of over-exercising and under-exercising are displayed to the patient 24 to help prevent injury and optimize their exercises. A review quiz (not shown) is displayed, where the patient is questioned on the lesson plan contents and is prompted to select from a list of possible answers, to submit the completed quiz for displaying the quiz results. The quiz reaffirms the lesson plan and promotes a healthful lifestyle way of thinking to the patient. The compliance log web page is displayed upon completion of the introduction to exercise and activity lesson plan, where the patient 24 is prompted to indicate their compliance with the treatment plan aspects and enter their body weight as described above.

The step of selecting the motivation and goal setting 356 lesson plan option displays a goal setting web page (not shown) comprising an overview of how education improves motivation, and information on health and excess body fat, how food affects moods, behavior and eating habits. The patient 24 is provided an individualized activity plan 62 set by the health provider 26, were default parameters are set by the computer program 30 according to the parameters as described above. The individualized activity plan 62 comprises adjustments to the caloric levels of the nutrition program that vary according to the intensity of exercise completed. The goal setting lesson plan 356 guides the patient 24 through a step-by-step process to set exercise goals appropriate for the patient 24. The patient 24 is presented information on stretching techniques, and warm up and cool down principles (not shown). A review quiz (not shown) is displayed, where the patient is questioned on the lesson plan contents and is prompted to select from a list of possible answers, to submit the completed quiz for displaying the quiz results. The quiz reaffirms the lesson plan and promotes a healthful lifestyle way of thinking to the patient. The compliance log web page (not shown) is displayed upon completion of the motivation and goal setting lesson plan 356, where the patient 24 is prompted to indicate their compliance with the treatment plan aspects and enter their body weight as described above.

The step of selecting the nutrition and weight management facts lesson plan 358 option displays a nutrition and weight management facts web page (not shown) comprising a nutrition review, a review of the principals of weight management, losing weight and keeping it off, a review health risks, and caveman cuisine regarding human eating history. Nutrition facts are displayed enabling the patient 24 to make informed purchasing and consumption decisions regarding their diet enabling the patient to begin their path to dietary recovery and independence. The patient 24 is instructed on how to read and interpret nutrition labels on foods. A review quiz (not shown) is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the nutrition and weight management facts lesson plan, where the patient 24 is prompted to indicate their compliance with the treatment plan aspects and enter their body weight as described above.

The step of selecting the more about exercise lesson plan 360 option displays a more about exercise web page (not shown) comprising exercise and lifestyle relationships, exercise questions and answers, and information on self-image, anaerobic threshold, and dehydration. The more about exercise lesson plan enables the patient 24 to evaluate their results by providing detailed information about attaining goals, self-image, positive visualization, habits and behavior identification. The more about exercise lesson plan 360 includes sophisticated information about exercise including aerobic zones, resistance training, muscle endurance, cardiovascular efficacy, flexibility and physiological effects of exercise. A review quiz (not shown) is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the nutrition and weight management facts lesson plan, where the patient 24 is prompted to indicate their compliance with the treatment plan aspects and enter their body weight as described above.

The step of selecting the eating habits lesson plan 362 option displays an eating habits web page (not shown) comprising information on eating habits, restaurants and food cues, brain biology, and how eating habits can change. The eating habits lesson plan (not shown) displays information about the starvation response and its relation to blood sugar levels, and how to avoid crossing the starvation response threshold. The eating habits lesson plan includes information on dining out, tips for ordering, alcohol consumption and its relation to blood sugar and overeating. A review quiz is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page is displayed upon completion of the eating habits lesson plan, where the patient 24 is prompted to indicate their compliance with the treatment plan aspects and enter their body weight as described above.

The step of selecting the nutrition supplements lesson plan 364 option displays a nutrition supplements web page (not shown) comprising a nutrition supplements overview, nutrition supplements basics, antioxidant update, and supplement updates. The nutrition supplements lesson plan 364 displays information for water-soluble versus fat-soluble vitamins, antioxidants, minerals and their importance to good nutrition. A review quiz (not shown) is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the nutrition supplements lesson plan 364, where the patient 24 is prompted to indicate their compliance with the treatment plan aspects and enter their body weight as described above.

The step of selecting the know your body lesson plan 366 option displays a know your body web page (not shown) comprising information on health risks, health concerns, obesity disease or symptoms, stress management, and coping with stress. The know your body lesson plan 366 provides the patient detailed information regarding human physiology and how it relates to diet, exercise, rest, age, gender, family history and morph-types, where the information is individualized by the individualized obesity treatment plan. A review quiz (not shown) is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the know your body lesson plan 366, where the patient 24 is prompted to indicate their compliance with the treatment plan aspects and enter their body weight as described above.

The step of selecting the behavior lesson plan 368 option displays a behavior web page (not shown) comprising information on weight management myths and facts, micro nutrition, eating behaviors, and behavior modification. There exists a substantial volume of misinformation regarding diet and weight loss. In general, most obese patients 24 have assimilated such information as fact and subsequently practice unhealthful lifestyles. The behavior lesson plan 368 provides information that clearly presents myths and facts about diet programs to further enable the necessary lifestyle changes for treating obesity. A review quiz (not shown) is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the behavior lesson plan, where the patient 24 is prompted to indicate their compliance with the treatment plan aspects and enter their body weight as described above.

The step of selecting the transition goals lesson plan 370 option displays a transition goals web page (not shown), comprising information on transition goals, the patient knowing their body, transition tips, and current health status. The transition goals lesson plan 370 enables the patient 24 to analyze their goals set in the goal setting lesson plan 370 of the prescription. The patient 24 is directed to determine healthful activities that satisfy their moods and emotions without food. The transition goals lesson plan 370 provides direction on modifying eating habits to manage cravings, and presents detailed information on mood and emotion management for achieving emotional balance with eating, and how to manage this causal relation to avoid inadvertent weight gain. A review quiz (not shown) is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the transition goals lesson plan, where the patient is prompted to indicate their compliance with the treatment plan aspects and enter their body weight as described above.

The step of selecting the maintenance lesson plan 372 option displays a maintenance web page (not shown) comprising information on maintenance overview, difficulties of weight maintenance, commendation on the patient 24 reaching their goal weight, maintaining their weight, and weight management strategies. The maintenance lesson plan 372 displays an overview of maintenance principles comprising an individualized program that sets forth the necessary directives to ensure successful, long-term weight management for the life of the patient. A review quiz (not shown) is displayed, where the patient 24 is questioned on the lesson plan contents and is prompted to select from a list of possible answers, to submit the completed quiz for displaying the quiz results. The quiz reaffirms the lesson plan and promotes a healthful lifestyle way of thinking to the patient 24. The compliance log web page (not shown) is displayed upon completion of the maintenance lesson plan, where the patient 24 is prompted to indicate their compliance with the treatment plan aspects and enter their body weight as described above.

FIG. 17 further depicts one embodiment of a patient web page having options for concurrent use with the lesson plans comprising: help 374, well-box new messages 376, community members online 378, menu planning sample recipes 380, cyber store 382, meal plan 384, aerobic exercises 386, resistance exercises 388, daily diary 390, nutrition analysis 392, my profile 394, food calculator for your PDA 396, and internet links national library of medicine 398. These options facilitate the patient 24 in their obesity treatment as they progress through each lesson plan described above.

The step of selecting the help 374 option displays a use information web page (not shown) having use information for the system and method comprising a lesson plan option, a meal plan option, an activity plan option, a my profile option, a my progress option, a compliance log option, a well-box new messages option, a calendar option, a cyber store option, a community, a log out, a well-box, a new messages, a send email to health provider, a review sent messages, a community, a members online, and a compose message to members on line option. Selecting from these options displays information (not shown) to the patient 24 on how to use the aspects of the selected topic.

The step of selecting the well-box new messages 376 option displays options to send and receive email with the health provider (not shown).

The step of selecting the community members online 378 option displays options to send and receive email between other patients in the obesity treatment plan (not shown). This option is particularly useful for patients using the Ornish diet type.

The step of selecting the menu planning sample recipes 380 option displays individualized sample recipes (not shown) for healthful meals and snacks according to a selected diet type from a diet category list comprising the Pritikin, Ornich, American Heart Association, Zone and Atkins diets, where the diets have daily intake values for protein, fat, and carbohydrates.

The step of selecting the cyber store 382 option displays product specifications and commerce information for diet supplements and health monitoring products (not shown).

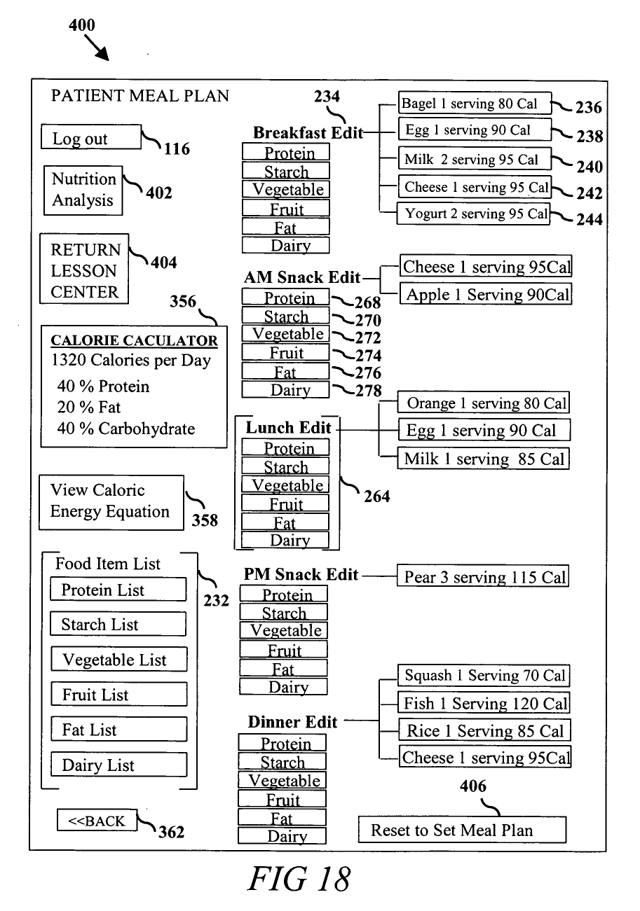

The step of selecting the meal plan 384 option displays an patient meal plan web page 400 having an individualized meal plan 60 depicted in FIG. 18 according to one embodiment of the invention. The default parameters of the patient meal plan web page 400 is derived from the diet type, compliance information, patient user profile, diagnostic data 42, health provider instructions, stored obesity treatment history data 54 and expert review board information 52. The individualized meal plan 60 comprises daily meals, having default caloric recommendations set by the health provider 26 for protein, carbohydrates and fat. The patient meal plan web page 400 further comprises options to review a food list 232, where the food list comprises protein, starch, vegetable, fruit, fat and dairy. The food list information comprises serving size, nutrition information, preparation and use information, and sample recipes. The patient meal plan web page 400 further comprises options to perform nutrition analysis 402, review the patient's individualized caloric energy equation 250 and edit daily menus. The patient meal plan web page 400 further comprises options to log out 116, return to the lesson plan web page 404, and reset to meal plan default parameters 406 as determined by the health provider. Other meal plan options enable a patient to edit a breakfast meal, a morning snack meal, a lunch meal, an evening snack meal and a dinner meal whereby the patient 24 is enabled to substitute, add and delete food items in the meals while remaining within the caloric settings from the health provider 26.

The patient meal plan web page 400 of FIG. 18, for discussion purposes is depicted with sample daily meals having caloric recommendations per day for protein, carbohydrates and fat, and options to review food list items 232, where selecting a review food list item displays a web page having information related to the selected food item in the food list, such as protein, starch, vegetable, fruit, fat and dairy. The food item information comprises serving size, nutrition, preparation and use, and sample recipes. Depicted in FIG. 18 are five food items in the breakfast edit list 234 comprising: a bagel 236, an egg 238, 2 servings of milk 240, 1 serving of cheese, 242 and 2 servings of yogurt 245.

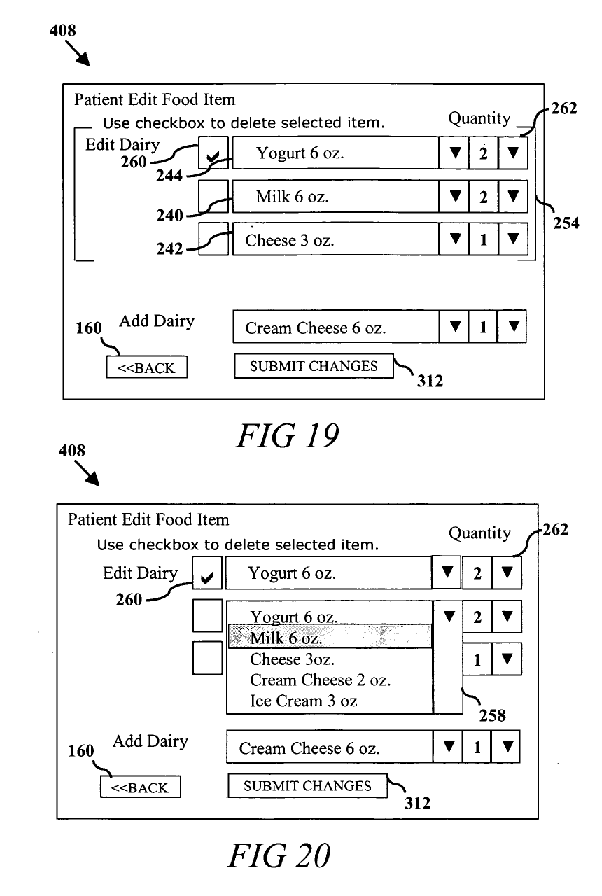

Each food item in a food item list is an option for displaying a patient edit food item web page 404, depicted in FIGS. 19 and 20, for the selected food item. FIGS. 19 and 20 depict patient edit food item web pages 408 according to one embodiment of the invention, where the patient 24 has selected the yogurt food 244 item from the breakfast food item list 234 in FIG. 18, and where the yogurt food item 244 is a dairy food item. The edit food item web page 408 displays a list of all dairy food items currently in the breakfast food item list 234 for the patient 24 to select from, where the food items in the patient food item lists are set by the health provider 26.

Depicted in FIG. 19, the example breakfast dairy food items comprise yogurt 244, milk 240 and cheese 242 and are displayed to the patient 24 in the patient edit food item web page 408. The patient 24 may select from other dairy food items in the dairy food item list set by the health provider 26 and stored in the secure database 32 by selecting a menu option for displaying the dairy food item list 254, where in this example, the menu option is a drop-down menu option 258 for displaying the dairy food item list as depicted in FIG. 20. Further depicted in FIGS. 19 and 20, are options to delete food items from the food item list, where the patient 24 selects a check box delete option 260 to indicate a food item to delete upon selecting a submit changes option 312. The patient selects a serving number option to assign a number of servings to a food item, where the health provider 26 has determined pre-set serving numbers for the patient 24 to select from. In the event of the patient 24 selecting too many food items or servings numbers such that the daily caloric values are exceeded, the health provider 26 is automatically notified by email and is given the discretion to approve or deny the additional calories for the plan. Further depicted in FIGS. 19 and 20 is an option to go back 160 to previous web page. This described embodiment of editing dairy food items in the breakfast meal plan is used for other food items such as starch, protein vegetable, fruit, fat and supplements, and is used for other meals such as AM snack, lunch, PM snack and dinner.

A food item nutrition analysis provides menu options prompting the patient 24 to select a food item in a food item list, a quantity and a serving size, according to the selected food category, then select an option to finish the nutrition analysis information input process, where a comprehensive food nutrition analysis web page is displayed to the patient.

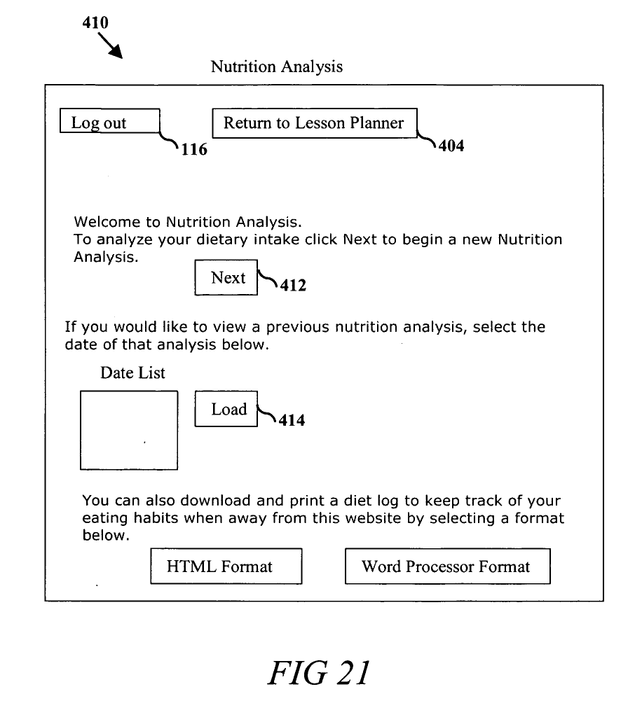

Selecting the nutrition analysis 402 option of FIG. 18 enables the patient 24 to make informed decisions in editing their meal plans 58, where a nutrition analysis web page 410 is displayed as depicted in FIG. 21. The nutrition analysis web page 410 has options to start a new nutrition analysis 412, or review previous nutrition analysis 414 in downloadable word processor document or hyper-text mark up language formats.

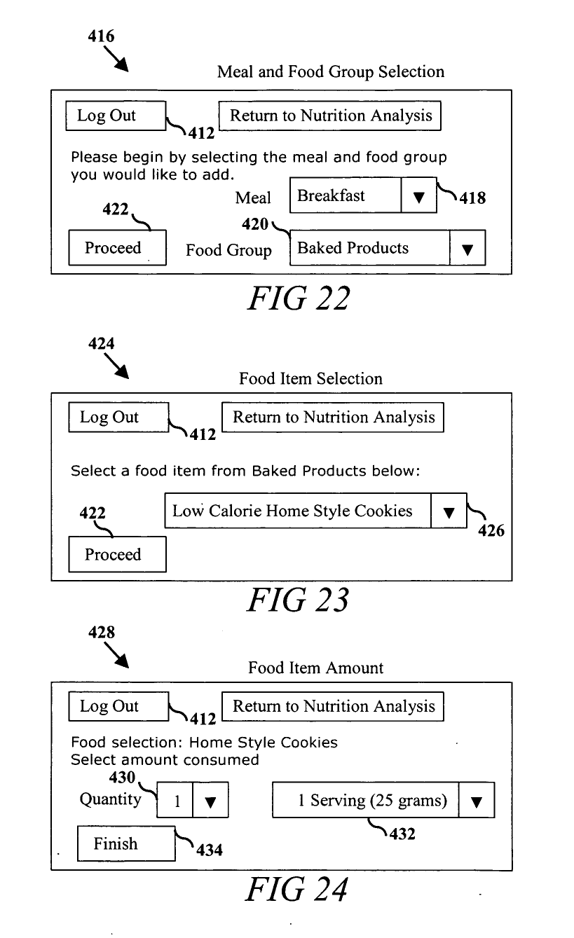

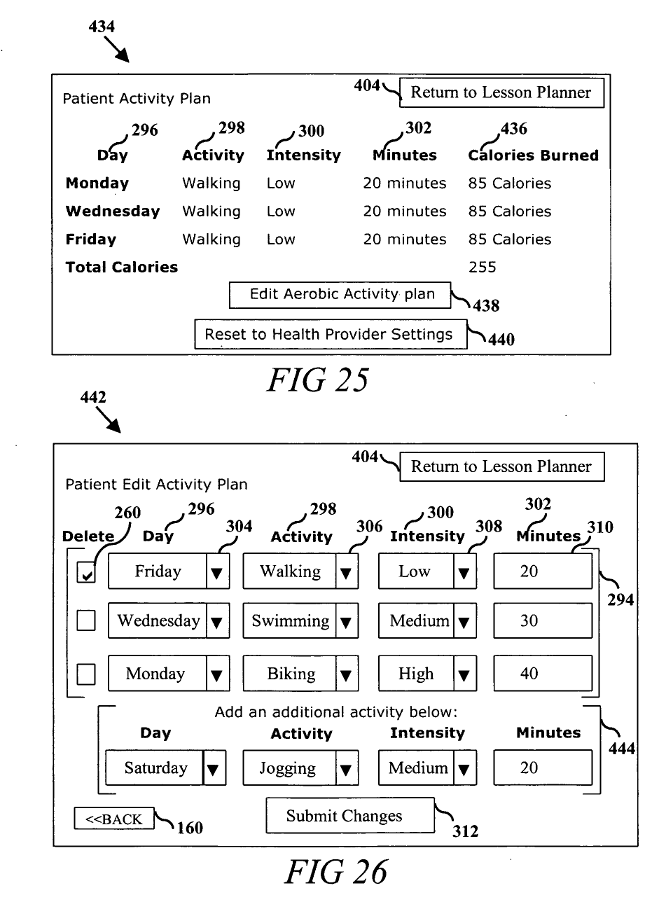

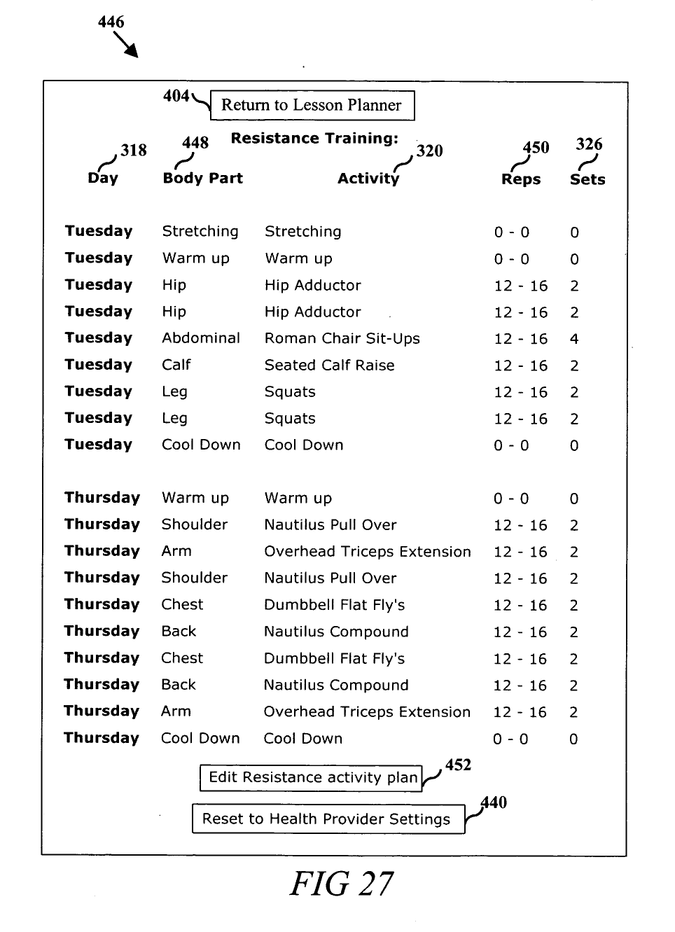

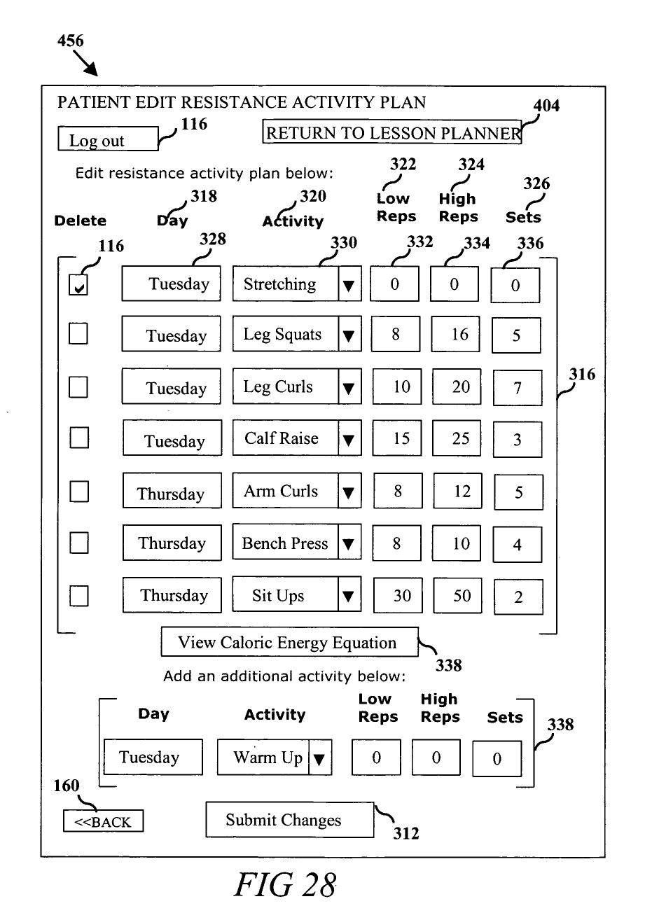

Selecting the option to start a new nutrition analysis 412 displays a meal and food group analysis web page 416, depicted in FIG. 22, prompting the patient 24 to select a meal from a displayed meal list 418 comprising breakfast, morning snack, lunch, evening snack, and dinner. The patient 24 is prompted to select a food group from a food group list 420 comprising baked products, beef products, beverages, breakfast cereals, cereal grains and pasta, dairy and egg products, fast foods, fats and oils, finfish and shellfish products, fruits and fruit juices, lamb, veal, and game products, legumes and legume products, meals, entrees, and side dishes, nut and seed products, pork products, poultry products, sausages and luncheon meats, snacks, soups, sauces, and gravies, spices and herbs, sweets and candy, vegetables and vegetable products, and baby foods.

The patient 24 is prompted to select an option to proceed 422, where a food item selection web page 424 is displayed, as depicted in FIG. 23, prompting the patient to select from a food item list 426 comprising any food items input to the selected food group 420 by the health provider 26, expert review board 36, or stored in the relational database 32.

The patient 24 is prompted to select the option to proceed 422, where a food item amount web page 428 is displayed, as depicted in FIG. 24. The food item amount web page 428 prompts the patient 24 to input the food item quantity 430 and serving size 432 and select an option to finish 433.

A comprehensive food nutrition analysis web page (not shown) is displayed comprising the date of analysis, and a nutrition fact sheet for the selected food items comprising quantitative values for total calories, calories from fat, total fat, saturated fat, monounsaturated fatty acids, polyunsaturated fatty acids, cholesterol, sodium, total carbohydrate, dietary fiber, sugars, protein, water, ash, calcium, iron, magnesium, phosphorus, potassium, zinc, copper, manganese, selenium, vitamin C, vitamin B6, vitamin B12, vitamin A, vitamin E, vitamin K, thiamin, riboflavin, niacin, and pantothenic acid and folic acids. This nutrition analysis may be performed in any food item in the food item list.

From the patient meal plan web page of FIG. 18, selecting the option to view the patient's individualized caloric energy equation 250 displays a current caloric energy equation web page (not shown) having the patient's current basal metabolic rate 68, specific dynamic action of foods 70, activities of daily living 72, calories burned by exercise 74, caloric energy requirements 74, caloric deficit for weight loss 78, and the caloric recommendation 78.

From the lesson planner web page of FIG. 17, selecting the aerobic exercises 386 option displays an aerobic exercise schedule web page 434, depicted in FIG. 24 having a plurality of aerobic activities assigned comprising a day 296, activity 298, intensity 300, duration 302, and calories burned 436, and having options to edit exercise schedule 438 or reset to set activity plan 440.

The step of selecting the option to edit the exercise schedule 438 displays an patent edit aerobic activity plan web page 442, depicted in FIG. 26, having an aerobic activity list 294 and options enabling the patient to edit, add and delete aerobic activity exercises, in the manner described above for the health provider 26 to modify aerobic activity exercises in the activity plan 62. Where the health provider 26 has enabled the patient settings to allow for patient 24 modifications, the patient 24 may add an aerobic activity exercise to an aerobic activity plan by selecting a day 296, activity 298 and intensity 300 and duration 302 to the add activity exercise prompts and the selecting the submit changes option 312. The patient 24 deletes a desired aerobic activity exercise, where the health provider has enabled the patient settings to do so, by selecting the check box delete option 260 to delete upon selecting the submit option 312.

From the lesson planner web page of FIG. 17, the step of selecting the resistance exercises 388 option displays a resistance exercise schedule web page 446, depicted in FIG. 34 having a day list 318, body part list 448, activity list 320, repetition range list 450 and number of sets list 326, and options to edit the resistance activity plan 452, and an option to reset to set resistance activity plan 454, as defined by the health provider 26.

The step of selecting the option to edit resistance activity plan 454 displays an edit patient resistance activity plan web page 456, depicted in FIG. 28, having a resistance activity exercise list 316 and options enabling the patient to add and delete resistance activity exercises in the activity plan 62. As depicted, the resistance activity exercise comprises a resistance activity day 318, a resistance activity 320, a high repetition value 322, a low repetition value 324 and a number of sets 326. To edit a resistance exercise, the patient selects a desired day from a day list option 328, a resistance activity 330 from a resistance activity list option, and inputs a low repletion 332, a high repetition 334, and a number of sets 336 value. The day list 318 comprises days of the week, and the resistance activity list 320 comprises overhead triceps extension, squats, roman chair sit-ups, warm up, reverse crunches, low back machine, nautilus torso, hip adductor, leg twist, side twist, shrugs, test, stretching, hanging leg raises, crunches, nautilus pull over, forearm, cool down, dumbbell flat fly's, laying leg raises, nautilus compound, wrist curl, and seated calf raise. The patient 24 inputs a high repetition numeric value 332, a low repetition numeric value 334 and a number of sets 336. Where the health provider has enabled the patient settings to allow for patient modifications, the patient may add a resistance activity to a resistance activity plan by selecting a day 318, activity 320, low repetition 324, high repetition 326 and number of sets 328 to the add resistance exercise prompts 338 and the selecting submit changes option 312. The patient 24 deletes a desired resistance activity exercise, where the health provider has enabled the patient settings to do so, by selecting a check box delete option 260 to indicate a resistance activity exercise to delete upon selecting the submit changes option 312.

From the lesson planner web page of FIG. 23, the step of selecting the daily diary option 390 displays a diary web page (not shown) having private diary entries made by the patient to improve expected results and an option to add new entries.

From the lesson planner web page of FIG. 23, selecting the my profile option 394 displays diagnostic data web page depicted in FIG. 36, having options to view lab values, body composition, health risk analysis, weight graph.

From the lesson planner web page of FIG. 23, selecting the food calculator for your PDA option 396 displays a downloads web page (not shown) having options for accessing the USDA National Nutrient Database for use on personal digital assistants (PDAs).

From the lesson planner web page of FIG. 23, selecting the internet links National Library of Medicine option 398 displays the National Library of Medicine web site (not shown).

At the conclusion of the multi-week obesity treatment lesson plan, the health provider 26 examines the patient 24 one final time to release the patient 24 from the individualized obesity treatment plan or to extend the program for additional time. The health provider web page 80 displays a health risk analysis 56 for the patient 24, having patient information graphs (not shown) comprising patient data and information spanning the entire obesity treatment plan comprising a glucose tracking profile, a lipid tracking profile, a blood pressure tracking profile and the body analysis tracking profile, in addition to the information input by the patient comprising a comprehensive review of the compliance checklist over the multi-week prescription.

An internet visitor may select the option to tour the obesity treatment plan displayed on the enter treatment plan web page, where a tour plan web page (not shown) displays a description of the obesity diagnosis and treatment plan and displays an information request form prompting the visitor to supply contact information for receiving further details. The tour web page displays options comprising virtual tour steps 1 through 6. The visitor may select a virtual tour step 1 option where the tour plan web page (not shown) displays information for physician reimbursement strategies for the obesity treatment plan and further displays a comparison chart of other commercial weight management programs. Selecting the option virtual tour step 2 the tour plan web page (not shown) displays information on how a health provider can write a prescription for the obesity treatment plan. Selecting the virtual tour step 3 option the tour plan web page (not shown) displays information to review a data acquisition form, electro lipid-graph and validation documentation, display validation abstract on obese population, abstract on using body mass indices to diagnose obesity, and a review of an electro lipid-graph data report. Selecting the virtual tour 4 displays the tour plan web page (not shown) displays having a sample lifestyle analysis questionnaire, a sample health risk analysis lesson plan, a sample lesson plan quiz, a sample caloric energy equation, a sample nutrition plan, a sample activity program, a sample compliance log, a sample email, a sample cyber diary, and a sample support group. Selecting the virtual tour step 5 option displays the tour plan web page (not shown) having a sample introduction letter from the health provider to the patients, and information on how to add a new patient, view existing patients, perform cyber rounds on current patients, email communication with patients, revenue strategies and CPT billing options, contact HealthPort, review medical literature. Selecting the virtual tour step 6 option displays an information request form.

In another embodiment of the invention, the computer terminal comprises a portable computer having a display and means for information input, such as a touch screen, menu buttons, key pad or voice activation, and data storage for operating the computer program and relational data storage system using the internet.

The current invention is designed to be simple to implement and use, and enable health risk factors to be identified, treated, followed and reduced, whereby the demand for unnecessary, anxiety driven medical services is reduced. Additionally, by having an easy to use, straightforward format and user interface, treatment and prevention outcome data can be gathered and analyzed to enhance future treatment outcomes. Risk factor reduction results in better treatment outcomes and healthcare cost reductions, whereby patient satisfaction with healthcare providers and health insurance providers is increased.

The current invention enables health providers 26 and/or staff to interact with patients 24 via e-mail and online newsletters, and patients 24 may interact with health providers 26 and/or staff via e-mail.

The current invention enables an individualized follow up program both near term and long term, where patients 24 have access to online progress journals, disease specific communities and disease specific content. Further, the current invention enables the patient 24 to engage obesity specific chat rooms and counselors, and enables e-mail interaction with the health provider. Greater patient education promotes patient compliance with treatment plans and gives health providers the ability to prescribe comprehensive individualized obesity treatment plans.

Health insurance plans and health providers have economic incentives to support the current invention, where it can provide new fee-for-service profit centers for health providers and can standardize disease management for managed care organizations and health maintenance organizations. Patients will pay for the useful aspects of the current invention out-of-pocket based on its efficacy, thus health providers are enabled to participate in the multi-billion dollar weight loss industry with a useful tool and method.

The current invention further provides foundation for turnkey corporate wellness and health promotion programs and for education sector preventive medicine teaching. Additionally, pharmaceutical and nutriceutical companies may use the current invention for marketing healthful products.

These embodiments are set forth by way of example and are not for the purpose of limiting the present invention. It will be readily apparent to those skilled in the art that obvious modifications, derivations and variations can be made to the embodiments without departing from the scope of the invention. Accordingly, the claims appended hereto should be read in their full scope including any such modifications, derivations and variations.

1) an individualized system and method of mass diagnosis and treatment of obesity that is optionally configurable for a plurality of patients and health providers comprising the steps of:
a. providing a computer and relational data storage system for operating a computer program and a secure web site on an internet; and
b. assigning user profiles to said health providers and said patients for accessing said secure web site using a plurality of computer terminals; and
c. gathering patient diagnostic data and patient subjective information for use in a health risk analysis to determine values for variables in a caloric energy equation; and
d. using an individualized health provider web page to administer a meal plan, an exercise plan and an education plan to influence variables in a caloric energy equation to derive an individualized caloric energy deficit and a starvation response threshold in said patient to enable body fat loss; and
e. gathering patient treatment plan compliance information using an individualized patient web page for use in said health risk analysis and for correlation with said stored data to re-derive said variables.

2) The system and method of claim 1 where said diagnostic data comprise:
a. examination date
b. date of birth
c. gender
d. blood laboratory values
e. height measurement
f. weight measurement
g. electro lipo-graph measurement
h. systolic measurement
i. diastolic measurement
j. heart rate measurement
k. waist measurement
l. hips measurement
m. date created

3) The system and method of claim 2 where said blood laboratory values comprise:
a. Cholesterol
b. Triglycerides
c. hemoglobin A1C
d. high-density lipid protein
e. low-density lipid protein
f. C reactive protein
g. lipid Peroxidase
h. glucose
i. homocysteine

4) The system and method of claim 1 where said patients comprise wellness participants and medical patients and said wellness participant diagnostic data omits said blood laboratory values.

5) The system and method of claim 4 where said medical patient health risk analysis comprises:
a. said diagnostic data
b. a graph of projected weight loss
c. a health risk age
d. a body composition analysis
e. a coronary risk analysis
f. a cancer risk analysis
g. a nutrition risk analysis
h. an exercise risk analysis
i. a non-controllable risk analysis
j. a lifestyle risk analysis
k. a personal safety risk analysis
l. a diabetes risk analysis
m. a hypertension risk analysis
n. an arthritis risk analysis
o. an osteoporosis risk analysis

6) The system and method of claim 4 where said wellness patient health risk analysis comprises:
a. said diagnostic data
b. a graph of projected weight loss
c. a health risk age
d. a body composition analysis
e. a coronary risk analysis
f. a cancer risk analysis
g. a nutrition risk analysis
h. an exercise risk analysis
i. a non-controllable risk analysis
j. a lifestyle risk analysis
k. a personal safety risk analysis.

7) The system and method of claim 1 where said computer program is optionally configured to enable and disable use of said blood laboratory results.

8) The system and method of claim 1 further comprises a multi-week lesson plan.

9) The method of claim 8 where said multi-week lesson plan options comprise:
a. Introduction to health risk analysis
b. introduction to nutrition
c. introduction to exercise and activity
d. motivation and goal setting
e. nutrition and weight management facts
f. more about exercise
g. eating habits
h. nutrition supplements
i. know your body
j. behavior
k. transition goals
l. maintenance

10) The system and method of claim 1 where said subjective information comprises:
a. family history
b. physical activity
c. nutrition habits
d. alcohol and drug use
e. stress management
f. health care habits
g. safety habits
h. weight management habits.

11) The system and method of claim 10 where said family history comprises:
a. family history of coronary heart disease before 60
b. family history of coronary heart disease after 60
c. family history of diabetes mellitus
d. family history of strokes
e. family history of cancer

12) The system and method of claim 10 where said physical activity comprises:
a. exercise frequency
b. exercise type
c. warm-up and cool-down
d. weight Training

13) The system and method of claim 10 where said nutrition habits comprise:
a. carbohydrate consumption
b. fat consumption
c. preparation of foods
d. cereal grain product use
e. convenience food use
f. intake of salt
g. daily meals consumed
h. daily snacks consumed
i. water consumption
j. dairy products consumed
k. fruits consumption
l. vegetable consumption
m. meat and protein products consumed.

14) The system and method of claim 10 where said alcohol and drug information comprises:
a. drinking days
b. number of drinks
c. drugs and self medication
d. caffeine consumption
e. smoking status and frequency
f. smokeless tobacco use.

15) The system and method of claim 10 where said stress management comprises:
a. stress and coping habits
b. energy level
c. sleep attained
d. anger management
e. pressure management
f. demands and obligations management
g. procrastination habits
h. future outlook perspectives
i. self needs fulfillment
j. respect habits
k. compulsive needs management
l. unfair events coping
m. recognition habits
n. responsibility management

16) The system and method of claim 10 where said health care habits comprise:
a. number of annual clinic visits
b. number of annual sick days
c. routine check-up or physical examination habits
d. mammogram examination habits
e. colon-rectal screening habits
f. prostate screening habits
g. cancer warning sign adherence
h. dental check-up habits
i. eye examination habits

17) The system and method of claim 10 where said safety habits comprise:
a. safety of living environment
b. smoke detector use
c. seat belt use
d. daily driving time
e. automobile maintenance habits
f. fire protection habits

18) The system and method of claim 10 where said weight management habits comprise:
a. healthful living habits
b. how long has the patient felt that their weight has been a problem
c. how many times has the patient been on a diet or attempted to lose weight
d. how much weight does the patient lose when dieting
e. what attempts at weight loss have been done
f. has the patient ever any bulimic events
g. how many individuals in the patient's direct family have a weight problem.

19) The system and method of claim 1 further comprises health provider web page options.

20) The system and method of claim 19 where said health provider options comprise:
a. add a new patient
b. view existing patients
c. patient search
d. view inactive patients
e. doctor's chat room
f. overview of treatment Plan
g. modify patient greeting letter
h. view cyber store
i. email communication with patients
j. send broadcast email to patients
k. revenue strategies and billing options
l. contact treatment plan provider
m. review medical literature
n. upload doctor photo
o. add supplements

21) The system and method of claim 20 wherein the step of selecting said add new patient option displays an add new patient web page prompting said medical professional to:
a. select a diet type
b. enter a new patient's name
c. enter said new patient's race
d. enter said new patient's contact information
e. enter a patient retest interval
f. enter a daily protein intake value
g. enter a daily fat intake value
h. enter a daily carbohydrate value
i. designate said medical patient as active or inactive
j. enable disable email access to said health provider
k. enter a daily caloric deficit value
l. designate exercise level ranging from light, moderate to heavy
m. enter an activities of daily living value ranging from light, medium to heavy
n. enable disable store active
o. enable disable use supplements
p. enable disable use cyber rounds
q. enter cyber care plan identification number generated by said health provider.

22) The system and method of claim 21 where said diet type comprises:
a. a Pritikin diet
b. an Ornich diet
c. an American Heart Association diet
d. a Zone diet
e. an Atkins diet

23) The system and method of claim 21 where said contact information comprises:
a. phone
b. mailing address
c. email
d. password

24) The system and method of claim 21 where said patient retest interval is between 1 and 12 weeks.

25) The system and method of claim 21 where said daily protein intake value ranges from 0-100% and has a default setting appropriate to said diet type.

26) The system and method of claim 21 where said said daily fat intake value ranges from 0-100% and has a default setting appropriate to said diet type.

27) The system and method of claim 21 where said daily carbohydrate intake value ranges from 0-100% and has a default setting appropriate to said diet type.

28) The system and method of claim 20 where selecting said view existing patients option displays a patient name list where each patient name in said list is an option to display patient details.

29) The system and method of claim 28 where selecting said patient name from said patient name list displays complete patient information stored in said data storage system and further displays options comprising:
a. review patients meal plan
b. review patients health risk analysis
c. review patients activity plan
d. edit patient's goal weight
e. edit patient's goal fat percentages
f. edit patient's caloric recommendation
g. view patient's weight graph
h. view patient's body composition
i. send patient an email

30) The system and method of claim 29 where selecting said review patients meal plan option displays options to edit said meals comprising breakfast, morning snack, lunch, afternoon snack, and dinner, where meal settings from said health provider supersedes meal modifications performed by said patient.

31) The system and method of claim 29 where selecting said review patients meal plan option further displays options for displaying food information comprising:
a. Protein
b. Starch
c. Vegetable
d. fruit
e. fat
f. dairy

32) The system and method of claim 29 where selecting said option to review said patients health risk analysis displays analysis information of said patient comprising:
a. said patient overall health risk based on said patients diagnostic data, body composition and subjective information
b. overview
c. health risk age
d. body composition
e. coronary risk
f. cancer risk
g. nutrition
h. exercise
i. non-controllable risks
j. lifestyle analysis
k. personal and safety
l. diabetes risk
m. hypertension risk
n. arthritis risk
o. osteoporosis risk

33) The system and method of claim 29 where selecting said option to review patients activity plan displays options to edit an aerobic activity plan, reset to default aerobic activity plan values, edit a resistance activity plan, and reset to default resistance activity values.

34) The system and method of claim 33 where selecting said option to edit patient aerobic activity plan displays options enabling said health provider to edit, add and delete aerobic activity exercise in an individualized activity plan.

35) The system and method of claim 33 where selecting said option to edit patient resistance activity plan displays options enabling said health provider to edit, add and delete resistance activity exercise in said individualized activity plan.

36) The system and method of claim 29 where selecting said option to edit this patient's goal weight displays said patient's current goal weight: and an option to enter a new goal weight.

37) The system and method of claim 29 where selecting said option to edit said patient's goal fat percentages displays a said patient's current goal fat percentage range comprising a low value and a high value and a prompt to enter a new goal fat percentage range for said patient.

38) The system and method of claim 29 where selecting said option to edit said patient's caloric recommendation displays options enabling said health provider to make specific caloric intake recommendations affecting said caloric deficit.

39) The system and method of claim 29 where selecting said option to view said patient's weight graph displays a weight graph according to daily weight measurements entered by said patient.

40) The system and method of claim 29 where selecting said option to view said patient's body composition measurements displays said patient's body composition data comprising:
a. measured lean body mass
b. percentage of lean body mass
c. lean body mass to fat ratio
d. total body water
e. optimal lean body mass to fat ratio
f. weight of body fat
g. desired range of percent body fat
h. percentage of body fat
i. fat free mass comprising muscles, body fluid, connective tissue and bones said patient's current weight composition goals comprising a percent body fat, a percent lean mass, percent excess fat and an Ideal body fat range.

41) The system method of claim 20 where selecting said patient search option displays a prompt for said health provider to input a desired patient's last name, first name, or obesity treatment plan username and select a search option to display a list of said patients that match said patient names or said user names.

42) The system method of claim 41 where each said name in said search results list is an option to display said complete patient information stored in said data storage system.

43) The system method of claim 20 where selecting said option to view inactive patients displays a list of inactive patients names and each said displayed patent name is an option to display said selected patient's information and treatment history comprising meal plans, health risk analysis, activity plans, goal weight histories, goal fat percentage histories, caloric recommendation histories, weight graphs, body composition histories, and emails sent to said patient.

44) The system method of claim 20 where selecting said option to enter doctor chat room displays a prompt to enter said health provider username and select a submit option to display a subject list of previously posted messages, and options enabling said health provider to post messages for exchanging information among colleagues.

45) The system method of claim 20 where selecting said option to modify patient greeting letter enables said health provider to review and modify a patient introduction letter for welcoming said patient to said treatment plan and provide a brief overview of what to expect.

46) The system method of claim 20 where selecting said option to view cyber store displays additional products and services available to said patient that are useful for weight reduction, health and fitness.

47) The system method of claim 20 where selecting said option to email communication with patients displays a patient name list, where each name in said list is an option to send an email to a selected name, and prompts said health provider to select said patent to email and displaying an email page for said health provider to create and send email information.

48) The system method of claim 20 where selecting said option to send broadcast email to patients displays a prompt for said health provider to enter a subject into a subject window and enter a message into a message window then select an option to send the message to all active and inactive patients on said health provider's list.

49) The system method of claim 20 where selecting said option to view revenue strategies and billing options guides said health provider through a step-by-step process of billing for services rendered through the individualized obesity treatment plan program as established in current procedural terminology required in all medical insurance billing procedures.

50) The system method of claim 20 where selecting said option to view contact treatment plan provider enables said health provider to contact said treatment plan provider regarding issues or comments.

51) The system method of claim 20 where selecting said option to review medical literature displays a library of medical journal and medical institution internet links for said health provider's review.

52) The system method of claim 20 where selecting said option to add supplements enables said health provider to add new dietary supplements to a meal item list by prompting said health provider to enter a new supplement name, the grams of protein per serving, the grams of carbohydrate per serving and the grams of fat per serving, and select an option to update said meal items to add said new supplement to said health provider's food list for selectively adding said new supplement to said patient's individualized meal plan.

53) The system and method of claim 1 where said caloric deficit is a percentage of calories removed from the medical patient's total caloric energy requirements.

54) The system and method of claim 1 where said individualized patient web page has options comprising:
a. introduction and health risk analysis overview
b. introduction to nutrition
c. introduction to exercise and activity
d. motivation and goal setting
e. nutrition and weight management facts
f. more about exercise
g. eating habits
h. nutrition supplements
i. know your body
j. behavior
k. transition goals maintenance.

55) The system and method of claim 54 where said lesson plan duration is one week and comprises setting goals, displaying daily lessons and review quizzes to said patient for improving nutrition, fitness and healthful lifestyle awareness.

56) The system and method of claim 54 where selecting said introduction and health risk analysis overview lesson plan option displays an introduction information comprising:
a. a review of diagnostic data including said patient's height, weight, resting pulse rate, blood pressure, body composition analysis and certain blood laboratory values where applicable
b. a projected weight loss graph
c. said patient's starting weight and the goal weight at the end of said multi-week treatment plan and a value for the average weight lost per week
d. activities and assignments for each week comprising a review of the diagnostic data and projected weight loss, a review of health risk analysis, an adjusted health risk age, and a body composition profile

57) The system and method of claim 56 where said review of health risk analysis displays a review of profiles for coronary risk, cancer risk and hypertension risk, arthritis risk and osteoporosis risk, and a review of nutrition, exercise, non-controllable risk and personal health & safety.

58) The system and method of claim 54 where selecting said introduction to nutrition lesson plan option displays information comprising:
a. an introduction to nutrition
b. reading a food label
c. healthful eating and menu planning
d. how successful dieters keep weight off
e. fat substitutes and carbohydrates
f. comprising body composition
g. exercise and nutrition
h. an individualized food exchange chart.

59) The system and method of claim 54 where selecting said introduction to exercise and activity option displays an exercise and activity web page comprising:
a. the role of exercise
b. aerobic exercise basics
c. introduction to resistance training
d. building muscle and bone
e. setting goals
f. exercise and training information comprising walking, cycling, rowing, swimming, jogging, running, stair climbing, weight training and cross country skiing

60) The system and method of claim 54 where selecting said motivation and goal setting option displays an overview of how education improves motivation, and information on health and excess body fat, how food affects moods, behavior and eating habits.

61) The system and method of claim 54 where selecting said nutrition and weight management facts option displays nutrition and weight management facts comprising:
a. a nutrition review
b. a review of the principals of weight management
c. losing weight and keeping it off
d. a review health risks
e. caveman cuisine regarding human eating history
f. how to read and interpret nutrition labels on foods.

62) The system and method of claim 54 where selecting said more about exercise option displays information comprising:
a. exercise and lifestyle relationships,
b. exercise questions and answers
c. self-image
d. anaerobic threshold
e. dehydration.

63) The system and method of claim 54 where selecting said eating habits option displays information comprising:
a. eating habits
b. restaurants and food cues
c. brain biology
d. how eating habits can change
e. starvation response and its relation to blood sugar levels
f. how to avoid crossing the starvation response threshold
g. dining out and tips for ordering
h. alcohol consumption and its relation to blood sugar
i. overeating.

64) The system and method of claim 54 where selecting said nutrition supplements option displays information comprising:
a. nutrition supplements overview
b. nutrition supplements basics
c. antioxidant update
d. supplement updates
e. water-soluble versus fat-soluble vitamins
f. antioxidants
g. minerals and their importance to good nutrition.

65) The system and method of claim 54 where selecting said know your body option displays information comprising:
a. health risks
b. health concerns
c. obesity disease or symptoms
d. stress management,
e. coping with stress.
f. human physiology and how it relates to diet
g. exercise
h. rest
i. age
j. gender
k. family history
l. morph-types.

66) The system and method of claim 54 where selecting said behavior option displays information comprising:
a. weight management myths and facts
b. micro nutrition
c. eating behaviors
d. behavior modification.
e. myths and facts about diet programs.

67) The system and method of claim 54 where selecting said transition goals option displays information comprising:
a. transition goals
b. knowing your body
c. transition tips
d. current health status
e. modifying eating habits to manage cravings
f. mood and emotion management for achieving emotional balance with eating, and how to manage this causal relation to avoid inadvertent weight gain.

68) The system and method of claim 54 where selecting said maintenance option displays information comprising:
a. maintenance overview
b. difficulties of weight maintenance
c. commendation on said patient reaching their goal weight
d. maintaining weight
e. weight management strategies.

69) The system and method of claim 1 where said individualized patient web page has options further comprising:
a. Help
b. wellbox new messages
c. community members online
d. menu planning sample recipes
e. cyber store
f. meal plan
g. aerobic exercises
h. resistance exercises
i. daily diary
j. nutrition analysis
k. my profile
l. food calculator for your PDA
m. internet links national library of medicine.

70) The system method of claim 69 where selecting said help option displays use information for said system and method comprising:
a. lesson plan
b. meal plan
c. activity plan
d. my profile
e. my progress
f. compliance log
g. wellbox
h. calendar
i. cyber store
j. community
k. log out
l. wellbox
m. new messages
n. send email to health provider
o. review sent messages
p. community
q. members online communication

71) The system method of claim 69 where selecting said well-box new messages option displays options to send and receive email with said health provider.

72) The system method of claim 69 where selecting said community members online option displays options enabling sending and receiving email between said patients.

73) The system method of claim 69 where selecting said menu planning sample recipes option displays individualized sample recipes for healthful meals and snacks.

74) The system method of claim 69 where selecting said cyber store option displays product specifications and commerce information for diet supplements and health monitoring products.

75) The system method of claim 69 where selecting said meal plan option displays an individualized meal plan comprising:
a. meals having food items options for editing said meals
b. caloric recommendation per day for protein, carbohydrates and fat
c. review food list options for displaying information for protein, starch, vegetable, fruit, fat and dairy comprising serving size, nutrition information, preparation and use information and sample recipes
d. perform nutrition analysis; and
e. review caloric energy equation; and
f. edit daily menus.

76) The system method of claim 75 where selecting said edit meal item options displays options enabling a patient to edit a breakfast meal, a morning snack meal, a lunch meal, an evening snack meal and a dinner meal enabling substitution, addition and subtraction of food items in said meals, where said food items are predetermined by said health provider.

77) The system method of claim 75 where selecting said perform nutrition analysis option displays a nutrition analysis options to start a new nutrition analysis, or review previous nutrition analysis in downloadable word processor document or hyper text mark up language formats.

78) The system method of claim 77 where selecting start new nutrition analysis option enables analysis of said patient's dietary intake by prompting said patient to select a meal from a displayed meal list comprising breakfast, morning snack, lunch, evening snack, and dinner
a. prompting said patient to enter a food from a food list comprising baked products, beef products, beverages, breakfast cereals, cereal grains and pasta, dairy and egg products, fast foods, fats and oils, finfish and shellfish products, fruits and fruit juices, lamb, veal, and game products, legumes and legume products, meals, entrees, and side dishes, nut and seed products, pork products, poultry products, sausages and luncheon meats, snacks, soups, sauces, and gravies, spices and herbs, sweets and candy, vegetables and vegetable products, baby foods
b. prompting said patient to enter an amount consumed of said food and select an option to proceed
c. displaying a comprehensive food analysis comprising a date of analysis and a nutrition fact sheet for said food item comprising quantitative values for total calories, calories from fat, total fat, saturated fat, monounsaturated fatty acids, polyunsaturated fatty acids, cholesterol, sodium, total carbohydrate, dietary fiber, sugars, protein, water, ash, calcium, iron, magnesium, phosphorus, potassium, zinc, copper, manganese, selenium, vitamin C, vitamin B6, vitamin B12, vitamin A, vitamin E, vitamin K, thiamin, riboflavin, niacin, pantothenic acid and folic acid.

79) The system method of claim 75 where selecting said view individualized caloric energy equation option displays individualized values for basal metabolic rate, specific dynamic action of foods, activities of daily living, calories burned by exercise, caloric energy requirements and calories for weight loss to provide a caloric recommendation.

80) The system method of claim 75 where selecting said edit daily menu option displays options to create individualized breakfast menus, morning snack menus, lunch menus, evening snack menus, and dinner menus
a. options to edit individualized breakfast menus, morning snack menus, lunch menus, evening snack menus, and dinner menus
b. an option to reset said meal plan to said default parameters
c. options to exchange meal plan elements comprising dairy, starch, protein, vegetables, fruit, fat and supplements.

81) The system method of claim 80 where selecting said edit individualized menu option prompts said patient to add and remove said food items from said menu and automatically remains within said caloric recommendations set by said health provider.

82) The system method of claim 69 where selecting said aerobic exercises option displays a default exercise schedule having a calendar, activities, intensity, duration, and calories burned options to create an individualized exercise calendar having a plurality of exercise activities and a plurality intensity levels to assign thereto for input to said program.

83) The system method of claim 69 where selecting said resistance exercises option displays a default resistance exercise schedule having a calendar, body part, resistance activity, repetition value, and a set value and calories burned and an option to create an individualized resistance exercise activity plan having a plurality of resistance exercise and a plurality of intensity levels to assign thereto for input to said program.

84) The system method of claim 69 where selecting said daily diary option displays private diary entries made by said patient to improve expected results and an option to add new said entry.

85) The system method of claim 69 where selecting said my profile option displays said patient diagnostic data and lab values, body composition, health risk analysis, weight graph.

86) The system method of claim 69 where selecting said food calculator for your PDA option displays downloadable information from the USDA national nutrient database for use on personal digital assistants (PDAs).

87) The system method of claim 69 where selecting said National Library of Medicine option displays said National Library of Medicine web site.

88) The system method of claim 1 where said secure web site further comprises a tour option for displaying information comprising:
a. said treatment plan overview an information request form
b. physician reimbursement strategies
c. weight management programs
d. write an prescription for said treatment plan
e. review data acquisition form
f. review bio-impedance and validation documentation
g. view validation abstract on obese population
h. view abstract on using body mass index to diagnose obesity
i. review a bio-impedance data report
j. view a sample lifestyle analysis questionnaire
k. review a sample health risk analysis lesson plan
l. review a sample lesson plan quiz
m. view a sample caloric energy equation
n. review a sample nutrition plan
o. review a sample activity program
p. review a sample compliance log
q. review a sample email
r. review a sample daily diary
s. review a sample support group
t. view sample introduction letter from doctor to patients
u. review add a new patient method
v. view existing sample patients
w. sample cyber rounds on patients
x. email communication with patients
y. revenue strategies and current procedural terminology CPT billing options
z. a description of said obesity diagnosis and treatment system and method.

89) A computer implemented method of mass diagnosis and treatment of obesity having optional configuration for supervision of a plurality of patient types by a plurality of health provider types comprising the steps of:
a. providing a computer program having computer instructions and a data storage system for displaying and operating an obesity treatment program and a predetermined secure web site using an internet
b. assigning user profiles to said health providers, comprising medical professionals and wellness practitioners, for input to said computer program and said data storage system
c. displaying said welcome web page prompting said medical professional to access a predetermined secure medical professional web page using said user profiles
d. displaying a medical professional web page having medical professional options to select there from to facilitate obesity treatment in said medical patient
e. displaying said welcome web page prompting said wellness practitioner to access a predetermined secure wellness practitioner web page using said user profiles
f. displaying said wellness practitioner web page having wellness practitioner options to select there from to facilitate obesity treatment in said wellness participant
g. obtaining examination results from a plurality of said patients to determine prescription needs, where said patients comprise medical patients and wellness participants
h. inputting said examination results to said computer program and said data storage system by said health providers, where said medical patients are examined by said medical professionals and said wellness participants are examined by said wellness practitioners
i. assigning user profiles to said patients by said health providers, where said medical patient user profiles are assigned by said medical professionals and said wellness participants user profiles are assigned by said wellness practitioners for input to said computer program and said data storage system
j. displaying said welcome web page prompting said medical patient to access a predetermined secure medical patient web page by using said medical patient user profiles
k. displaying said medical patient web page having medical patient options to select from to prompt actions to promote obesity healing
l. displaying said welcome web page prompting said wellness participant to access a predetermined secure wellness participant web page by using said wellness participant user profiles
m. displaying said wellness participant web page having wellness participant options to select from to prompt actions to promote obesity healing
n. displaying said welcome web page having a tour option enabling internet visitors to review said obesity diagnosis and treatment plan features using said obesity treatment program to integrate said examination results, said health provider prompted actions and said patient prompted actions to create an individualized obesity treatment plan.

90) A method for determining an individualized caloric energy deficit for an obese patient to lose weight comprising the steps of:
a. providing a computer having a computer program and a relational database for operating a secure website on an internet
b. inputting patient diagnostic data and subjective information
c. correlating patient health risks with stored health risk data using said computer program and said relational database to derive a health risk analysis
d. correlating said health risk analysis with health provider instructions using the computer program and relational database to derive individualized patient meal plans, patient activity plans, and education plans
e. correlating said health risk analysis, said health provider instructions and said individualized patient plans using the computer program and relational database to derive an individualized caloric energy equation
f. correlating said health risk analysis, said health provider instructions, and said individualized caloric energy equation using the computer program and relational database to derive an individualized caloric energy deficit
g. gathering patient compliance data correlating with stored patient compliance data using said computer program and said relational database to derive suggested plan modifications for approval by said health provider.
